(19) United States
(12) Patent Application Publication
(10) Pub. No.: US 2025/0324200 A1
(43) Pub. Date: Oct. 16, 2025

(54) ULTRASONIC TRANSDUCER

(71) Applicant: Murata Manufacturing Co., Ltd., Nagaokakyo-shi (JP)

(72) Inventor: Hironari YAMAMOTO, Nagaokakyo-shi (JP)

(21) Appl. No.: 19/196,132

(22) Filed: May 1, 2025

Related U.S. Application Data
(63) Continuation of application No. PCT/JP2024/037323, filed on Oct. 21, 2024.

(30) Foreign Application Priority Data
Apr. 16, 2024 (JP) 2024-065888

(51) Int. Cl. H04R 7/02

(52) U.S. Cl. CPC H04R 7/02

(57) ABSTRACT

In an ultrasonic transducer, at least one unimorph piezoelectric vibrator includes a piezoelectric body facing a first diaphragm with a space therebetween and a second diaphragm on an opposite side of the piezoelectric body from frame bodies. The first diaphragm includes openings at both end portions in a longitudinal direction inside each of the frame bodies. The first diaphragm is configured to resonantly vibrate in a phase opposite to a phase of the at least one unimorph piezoelectric vibrator orthogonal to the first diaphragm. Inside the frame bodies, longitudinal dimensions are 4 times or more and 11 times or less than lateral dimensions. The lateral dimensions of the frame bodies are identical or substantially identical to each other. A difference in the longitudinal dimensions of the frame bodies adjacent to each other in the longitudinal direction is equal to or less than the lateral dimensions.

### CROSS REFERENCE TO RELATED APPLICATIONS

This application claims the benefit of priority to Japanese Patent Application No. 2024-065888 filed on Apr. 16, 2024 and is a Continuation Application of PCT Application No. PCT/JP2024/037323 filed on Oct. 21, 2024. The entire contents of each application are hereby incorporated herein by reference.

### BACKGROUND OF THE INVENTION

### 1. Field of the Invention

The present invention relates to ultrasonic transducers.

### 2. Description of the Related Art

Japanese Unexamined Patent Application Publication No. 2003-47085 and Japanese Patent No. 6333480 disclose structures of a superdirective acoustic device. The superdirective acoustic device described in Japanese Unexamined Patent Application Publication No. 2003-47085 includes a plurality of ultrasonic vibrators deployed on a single printed circuit board, and the plurality of ultrasonic vibrators are disposed such that the outer periphery thereof defines a substantially circular shape. The plurality of ultrasonic vibrators are divided into two groups having different installation heights.

The superdirective acoustic device described in Japanese Patent No. 6333480 includes a first ultrasonic wave emitter and a second ultrasonic wave emitter. The second ultrasonic wave emitter is disposed on the axis of the first ultrasonic wave emitter and in front of the radiation surface of the first ultrasonic wave emitter. The phase of a carrier signal emitted by the second ultrasonic wave emitter is opposite to the phase of a carrier signal contained in a signal emitted by the first ultrasonic wave emitter.

### SUMMARY OF THE INVENTION

In the superdirective acoustic device described in Japanese Unexamined Patent Application Publication No. 2003-47085, since the plurality of ultrasonic vibrators in two groups having different installation heights are disposed, the structure is complex. In the superdirective acoustic device described in Japanese Patent No. 6333480, since the second ultrasonic wave emitter is disposed outside the first ultrasonic wave emitter, the device becomes larger.

Example embodiments of the present invention provide ultrasonic transducers each having a simple and small-sized structure that increases an acoustic pressure level while reducing internal stress.

An ultrasonic transducer according to an example embodiment of the present invention includes a first diaphragm, a plurality of frame bodies, and at least one unimorph piezoelectric vibrator. The plurality of frame bodies extend in a longitudinal direction, are arranged adjacently to each other in the longitudinal direction, and are joined to the first diaphragm. At least one unimorph piezoelectric vibrator is attached to the plurality of frame bodies. At least one unimorph piezoelectric vibrator includes a piezoelectric body facing the first diaphragm with a space therebetween and a second diaphragm provided on an opposite side of the piezoelectric body from the frame bodies. The first diaphragm includes a plurality of openings at both end portions in the longitudinal direction inside each of the plurality of frame bodies. The first diaphragm is configured to resonantly vibrate in a phase opposite to a phase of the at least one unimorph piezoelectric vibrator in a direction orthogonal to the first diaphragm. Inside each of the plurality of frame bodies, a longitudinal dimension in the longitudinal direction is about 4 times or more and about 11 times or less than a lateral dimension in a lateral direction orthogonal to the longitudinal direction. The lateral dimensions of the plurality of frame bodies are identical or substantially identical to each other. A difference between the longitudinal dimensions of the frame bodies adjacent to each other in the longitudinal direction the plurality of frame bodies is equal to or less than the lateral dimension.

In the ultrasonic transducers according to example embodiments of the present invention, it is possible to increase the acoustic pressure level while reducing internal stress by using a simple and small-sized structure.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a vertical sectional view illustrating the structure of an ultrasonic transducer according to example embodiment 1 of the present invention.

FIG. 2 is an exploded perspective view illustrating the structure of the ultrasonic transducer according to example embodiment 1 of the present invention.

FIG. 3 is a perspective view illustrating the structure of frame bodies of the ultrasonic transducer according to example embodiment 1 of the present invention.

FIG. 4 is a diagram of the ultrasonic transducer in FIG. 2 as viewed in the direction of arrow IV.

FIG. 5 is a sectional view illustrating the structure of a unimorph piezoelectric vibrator of the ultrasonic transducer according to example embodiment 1 of the present invention.

FIG. 6 is a perspective view illustrating a displacement state obtained by simulation analysis using a finite element method when the ultrasonic transducer according to example embodiment 1 of the present invention was transmitting or receiving ultrasonic waves.

FIG. 7 is a sectional view of the ultrasonic transducer in FIG. 6 as viewed in the direction of arrows VII-VII.

FIG. 8 is a graph illustrating the transition of the resonant frequency of a first diaphragm obtained by simulation analysis using a finite element method when a longitudinal dimension was changed with a lateral dimension inside the frame body fixed.

FIG. 9 is a graph illustrating the transition of the acoustic pressure of ultrasonic waves transmitted by the ultrasonic transducer obtained by simulation analysis using a finite element method when the longitudinal dimension was changed with the lateral dimension inside the frame body fixed.

FIG. 10 is an exploded perspective view illustrating the structure of an ultrasonic transducer according to comparative example 1.

FIG. 11 is a perspective view illustrating a displacement state obtained by simulation analysis using a finite element method when the ultrasonic transducer according to comparative example 1 was transmitting or receiving ultrasonic waves.

FIG. 12 is a graph obtained by actually measuring an applied voltage by a processing circuit and the transition of the acoustic pressure level for the ultrasonic transducer according to comparative example 1, which includes two frame bodies and has a distance in the second direction (Y-axis direction) between the first short-side portions of 30 mm and the ultrasonic transducer according to comparative example 1.

FIG. 13 is a graph illustrating the transition of the acoustic pressure of ultrasonic waves transmitted by the ultrasonic transducer obtained by simulation analysis using a finite element method when the dimension of the opening portions in the lateral direction was changed.

FIG. 14 is a perspective view illustrating a displacement state obtained by simulation analysis using a finite element method when an ultrasonic transducer according to sample 1 in which the ratio of the dimension of the opening portions in the lateral direction to the lateral dimension of the frame body was 0% was transmitting or receiving ultrasonic waves.

FIG. 15 is a perspective view illustrating a displacement state obtained by simulation analysis using a finite element method when an ultrasonic transducer according to sample 2 in which the ratio of the dimension of the opening portions in the lateral direction to the lateral dimension of the frame body was 33% was transmitting or receiving ultrasonic waves.

FIG. 16 is a perspective view illustrating a displacement state obtained by simulation analysis using a finite element method when an ultrasonic transducer according to sample 3 in which the ratio of the dimension of the opening portions in the lateral direction to the lateral dimension of the frame body was 100% was transmitting or receiving ultrasonic waves.

FIG. 17 is an exploded perspective view illustrating the structure of an ultrasonic transducer according to comparative example 2.

FIG. 18 is a perspective view illustrating a displacement state obtained by simulation analysis using a finite element method when the ultrasonic transducer according to comparative example 2 was transmitting or receiving ultrasonic waves.

FIG. 19 is a graph illustrating the transition of the acoustic pressure of ultrasonic waves transmitted by the ultrasonic transducer according to comparative example 2 obtained by simulation analysis using a finite element method when the dimension of the opening portions in the lateral direction was changed.

FIG. 20 is an exploded perspective view illustrating the structure of an ultrasonic transducer according to comparative example 3.

FIG. 21 is a perspective view illustrating a displacement state obtained by simulation analysis using a finite element method when the ultrasonic transducer according to comparative example 3 was transmitting or receiving ultrasonic waves with a frequency of 150 kHz.

FIG. 22 is a perspective view illustrating a displacement state obtained by simulation analysis using a finite element method when the ultrasonic transducer according to comparative example 3 was transmitting or receiving ultrasonic waves with a frequency of 150.4 kHz.

FIG. 23 is a perspective view illustrating a displacement state obtained by simulation analysis using a finite element method when an ultrasonic transducer according to comparative example 4 was transmitting or receiving ultrasonic waves.

FIG. 24 is an exploded perspective view illustrating the structure of an ultrasonic transducer according to modification 1 of example embodiment 1 of the present invention.

FIG. 25 is a perspective view illustrating a displacement state obtained by simulation analysis using a finite element method when the ultrasonic transducer according to modification 1 was transmitting or receiving ultrasonic waves.

FIG. 26 is an exploded perspective view illustrating the structure of an ultrasonic transducer according to modification 2 of example embodiment 1 of the present invention.

FIG. 27 is a perspective view illustrating a displacement state obtained by simulation analysis using a finite element method when the ultrasonic transducer according to modification 2 was transmitting or receiving ultrasonic waves.

FIG. 28 is an exploded perspective view illustrating the structure of an ultrasonic transducer according to modification 3 of example embodiment 1 of the present invention.

FIG. 29 is a perspective view illustrating a displacement state obtained by simulation analysis using a finite element method when the ultrasonic transducer according to modification 3 was transmitting or receiving ultrasonic waves.

FIG. 30 is a diagram of the ultrasonic transducer in FIG. 29 as viewed in the direction of arrow XXX.

FIG. 31 is a diagram of the ultrasonic transducer according to modification 3 as viewed from the second diaphragm.

FIG. 32 is an exploded perspective view illustrating the structure of an ultrasonic transducer according to modification 4 of example embodiment 1 of the present invention.

FIG. 33 is a perspective view illustrating a displacement state obtained by simulation analysis using a finite element method when the ultrasonic transducer according to modification 4 was transmitting or receiving ultrasonic waves.

FIG. 34 is a diagram of the ultrasonic transducer in FIG. 33 as viewed in the direction of arrow XXXIV.

FIG. 35 is an exploded perspective view illustrating the structure of an ultrasonic transducer according to modification 5 of example embodiment 1 of the present invention.

FIG. 36 is a perspective view illustrating a displacement state obtained by simulation analysis using a finite element method when the ultrasonic transducer according to modification 5 was transmitting or receiving ultrasonic waves.

FIG. 37 is a diagram of the ultrasonic transducer in FIG. 36 as viewed in the direction of arrow XXXVII.

FIG. 38 is a perspective view illustrating a displacement state obtained by simulation analysis using a finite element method when an ultrasonic transducer according to comparative example 5 in which a unimorph piezoelectric vibrator resonantly was vibrating in a bending mode was transmitting or receiving ultrasonic waves.

FIG. 39 is an exploded perspective view illustrating the structure of an ultrasonic transducer according to example embodiment 2 of the present invention.

FIG. 40 is a back view of the ultrasonic transducer in FIG. 39 as viewed in the direction of arrow XL.

FIG. 41 is a plan view illustrating the positional relationship in the first direction (X-axis direction) in a process of cutting the piezoelectric body of the ultrasonic transducer according to example embodiment 2 of the present invention.

### DETAILED DESCRIPTION OF THE EXAMPLE EMBODIMENTS

Ultrasonic transducers according to example embodiments of the present invention will be described with reference to the drawings. In the following description of the example embodiments, identical or corresponding components in the drawings are denoted by the same reference numerals to omit the description thereof. Example embodiments of the present invention are applicable to applications that require high-acoustic-pressure ultrasonic waves, such as ultrasonic transducers for parametric speakers, ultrasonic sensors, or non-contact haptics. An ultrasonic transducer for parametric speakers will be described as an example in the following example embodiments, but the application of the ultrasonic transducer is not limited to this.

### Example Embodiment 1

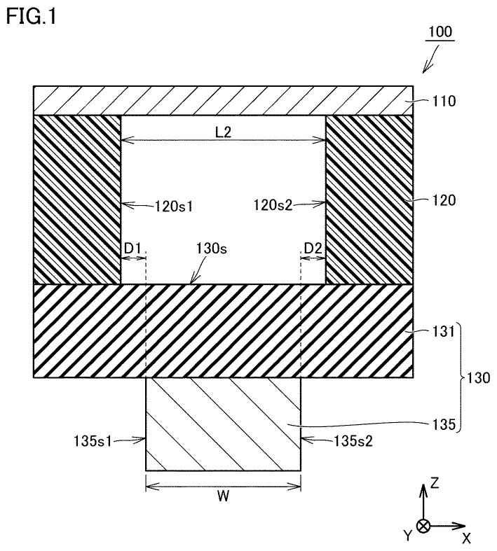

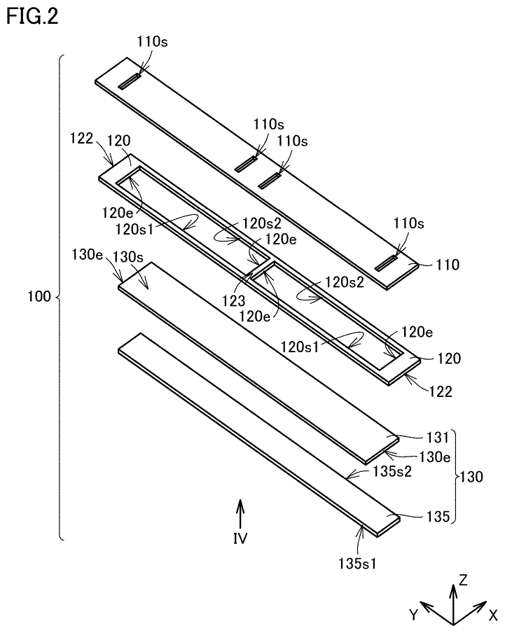

FIG. 1 is a vertical sectional view illustrating the structure of an ultrasonic transducer according to example embodiment 1 of the present invention. FIG. 2 is an exploded perspective view illustrating the structure of the ultrasonic transducer according to example embodiment 1 of the present invention. As illustrated in FIGS. 1 and 2, an ultrasonic transducer 100 according to example embodiment 1 of the present invention includes a first diaphragm 110, a plurality of frame bodies 120, and a unimorph piezoelectric vibrator 130.

The first diaphragm 110 has a flat shape. The first diaphragm 110 is made of a metal, which is an aluminum alloy, such as duralumin including aluminum, or a stainless steel. In the present example embodiment, the first diaphragm 110 is made of an aluminum alloy. Since an aluminum alloy has a small Young's modulus, the stress generated in the first diaphragm 110 when the ultrasonic transducer 100 is driven can be reduced by the first diaphragm 110 being made of an aluminum alloy. The thickness of the first diaphragm 110 is, for example, about 0.05 mm or more and about 0.2 mm or less.

The plurality of frame bodies 120 have a rectangular or substantially rectangular track shape. The plurality of frame bodies 120 have a lateral direction along a first direction (X-axis direction) and a longitudinal direction along a second direction (Y-axis direction). The plurality of frame bodies 120 extend in the second direction (Y-axis direction). The axial directions of the plurality of frame bodies 120 are along the third direction (Z-axis direction). The plurality of frame bodies 120 are arranged adjacent to each other in the longitudinal direction. In the example illustrated in FIG. 2, the two frame bodies 120 are arranged adjacent to each other in the second direction (Y-axis direction). However, the number of frame bodies 120 arranged adjacent to each other in the second direction (Y-axis direction) is not limited to two and may be three or more. One end in the third direction (Z-axis direction) of each of the plurality of frame bodies 120 is joined to the first diaphragm 110 with a joining material including epoxy resin or the like.

The frame bodies 120 are formed of a glass epoxy, a resin, or a metal, such as an aluminum alloy, an iron-nickel alloy (42Ni—Fe), or a stainless steel. The frame bodies 120 are preferably made of a metal to reduce or prevent characteristic changes due to temperature changes of the ultrasonic transducer 100. On the other hand, the frame bodies 120 are preferably made of a resin to reduce the frequency of the ultrasonic waves transmitted or received by the ultrasonic transducer 100 and reduce the size of the ultrasonic transducer 100. In the present example embodiment, the frame bodies 120 are made of an aluminum alloy. The thickness of the frame bodies 120 is, for example, about 0.2 mm or more and about 0.6 mm or less.

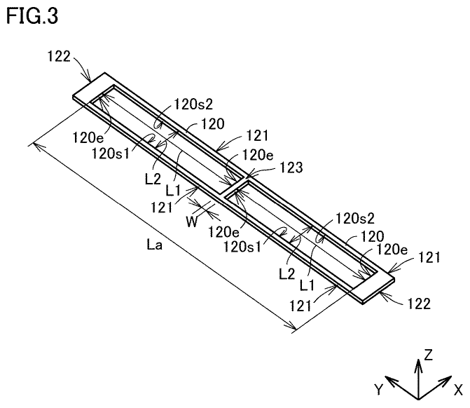

FIG. 3 is a perspective view illustrating the structure of the frame bodies of the ultrasonic transducer according to example embodiment 1 of the present invention. As illustrated in FIG. 3, each of the plurality of frame bodies 120 includes a pair of long-side portions 121 that extend in the second direction (Y-axis direction) and a first short-side portion 122 and a second short-side portion 123 that extend in the first direction (X-axis direction). The first short-side portions 122 are both end portions of the plurality of frame bodies 120 located at both ends in the second direction (Y-axis direction). The second short-side portion 123 is a connection end portion that connects the frame bodies 120 adjacent to each other in the second direction (Y-axis direction) of the plurality of frame bodies 120.

The pair of long-side portions 121, the first short-side portion 122, and the second short-side portion 123 are connected to define the inner peripheral surface of the frame body 120. The average distance between the first short-side portion 122 and the second short-side portion 123 is about 4 times or more and about 11 times or less the shortest distance between the long-side portions 121. That is, inside the plurality of frame bodies 120, a longitudinal dimension L1 in the second direction (Y-axis direction) is about 4 times or more and about 11 times or less than a lateral dimension L2 in the first direction (X-axis direction). The longitudinal dimension L1 is, for example, about 19 mm or more and about 22 mm or less to increase the acoustic pressure level of ultrasonic waves transmitted by ultrasonic transducer 100. The difference between the longitudinal dimensions L1 of the frame bodies 120 adjacent to each other in the second direction (Y-axis direction) of the plurality of frame bodies 120 is equal to or less than the lateral dimension L2. In the present example embodiment, the longitudinal dimensions L1 of the frame bodies 120 adjacent to each other in the second direction (Y-axis direction) of the plurality of frame bodies 120 are identical or substantially identical to each other.

A distance La between the first short-side portions 122 in the second direction (Y-axis direction) is the sum of the longitudinal dimensions L1 of the plurality of frame bodies 120 and the width dimension W of the second short-side portion 123 in the second direction (Y-axis direction). In the example illustrated in FIG. 3, the relationship La=L1×2+W is satisfied. The width dimension W of the second short-side portion 123 is, for example, about 0.3 mm or more and about 1 mm or less.

It should be noted that the corner portions between the first short-side portion 122 or the second short-side portions 123 and the long-side portions 121 may be chamfered. In addition, as viewed in the third direction (Z-axis direction), the shapes of the first short-side portions 122 and the second short-side portion 123 are not limited to straight lines and may be arcs that protrude toward the inside of the frame body 120 or arcs that protrude toward the outside of the frame body 120.

The resonant frequency of the first diaphragm 110 can be adjusted by the lateral dimension L2 in the first direction (X-axis direction) inside the frame body 120 being changed. For example, when the resonant frequency of the first diaphragm 110 is set to about 100 kHz or higher, the lateral dimension L2 described above is about 1.5 mm or more and about 3 mm or less. The lateral dimensions L2 of the plurality of frame bodies 120 are identical or substantially identical to each other.

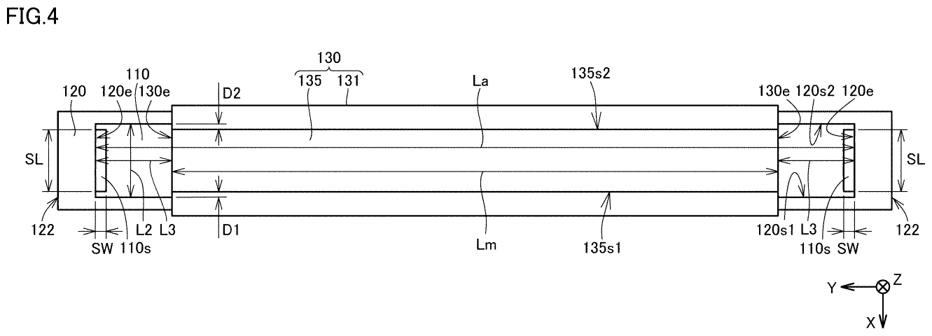

FIG. 4 is a diagram of the ultrasonic transducer in FIG. 2 as viewed in the direction of arrow IV. As illustrated in FIGS. 1 and 4, the unimorph piezoelectric vibrator 130 is attached to the plurality of frame bodies 120. The unimorph piezoelectric vibrator 130 includes a piezoelectric body 131 facing the first diaphragm 110 with a space therebetween and a second diaphragm 135 provided on an opposite side of the piezoelectric body 131 from the frame bodies 120. The piezoelectric body 131 has a rectangular parallelepiped shape. The thickness of the piezoelectric body 131 is, for example, about 0.1 mm or more and about 0.2 mm or less. The piezoelectric body 131 is made of, for example, a piezoelectric ceramic.

The second diaphragm 135 is made of a glass epoxy, a ceramic, or a metal, such as an aluminum alloy, an iron-nickel alloy (42Ni—Fe), or a stainless steel. In the present example embodiment, the second diaphragm 135 is made of an iron-nickel alloy (42Ni—Fe). The second diaphragm 135 has a rectangular parallelepiped shape. The second diaphragm 135 is joined to the piezoelectric body 131. The length of the second diaphragm 135 in the second direction (Y-axis direction) is equivalent to the length of the piezoelectric body 131 in the second direction (Y-axis direction). The lateral dimension of the second diaphragm 135 in the first direction (X-axis direction) is (⅔)×L2 or more and L2 or less where the lateral dimension L2 in the first direction (X-axis direction) inside the frame body 120. The thickness of the second diaphragm 135 is, for example, about 0.2 mm or more and about 0.4 mm or less. It should be noted that, when the shape of the second diaphragm 135 as viewed in the third direction (Z-axis direction) is not a rectangle but an ellipse or the like, the lateral dimension of the second diaphragm 135 is an average value.

As illustrated in FIG. 4, the second diaphragm 135 is located in a region interposed, in the first direction (X-axis direction), between both edges 120s1 and 120s2 in the first direction (X-axis direction) of the inner peripheral surface of each of the plurality of frame bodies 120 as viewed in the third direction (Z-axis direction) orthogonal to the first diaphragm 110.

As illustrated in FIG. 1, in the second diaphragm 135, an average distance D1 in the first direction (X-axis direction) between one edge 120s1 in the first direction (X-axis direction) of the inner peripheral surface of the frame body 120 and one edge 135s1 in the first direction (X-axis direction) of the second diaphragm 135 and an average distance D2 in the first direction (X-axis direction) between the other edge 120s2 in the first direction (X-axis direction) of the inner peripheral surface of the frame body 120 and another edge 135s2 in the first direction (X-axis direction) of the second diaphragm 135 are ⅙ or less the lateral dimension L2 in the first direction (X-axis direction) inside the frame body 120.

As illustrated in FIG. 4, the distance La between the first short-side portions 122 in the second direction (Y-axis direction) is greater than a minimum dimension Lm of the piezoelectric body 131 of the unimorph piezoelectric vibrator 130 in the second direction (Y-axis direction). The minimum dimension Lm of the piezoelectric body 131 of the unimorph piezoelectric vibrator 130 in the second direction (Y-axis direction) is the minimum dimension in the second direction (Y-axis direction) of one of a plurality of piezoelectric bodies that has the shortest length in the second direction (Y-axis direction) when the unimorph piezoelectric vibrator 130 has a laminated structure including the plurality of laminated piezoelectric bodies. For example, when the unimorph piezoelectric vibrator 130 has a laminated structure including two piezoelectric bodies 131 laminated together, polarization directions of the two piezoelectric bodies 131 face each other in the third direction (Z-axis direction). Since electric fields applied to the two piezoelectric bodies 131 are also opposite to each other in the third direction (Z-axis direction), the unimorph piezoelectric vibrator includes the two piezoelectric bodies 131 that perform bending vibration in the same manner.

In FIG. 4, the piezoelectric body 131 and the second diaphragm 135 overlap each other without being displaced in the second direction (Y-axis direction). It should be noted that the length of the piezoelectric body 131 in the second direction (Y-axis direction) is smaller than the distance La between the first short-side portions 122 in the second direction (Y-axis direction), but the present invention is not limited to this example, and the length of the piezoelectric body 131 may be equal to or greater than the distance La between the first short-side portions 122 in the second direction (Y-axis direction).

An average distance L3 in the second direction (Y-axis direction) of the space between an edge 120e of the inner peripheral surface of the frame body 120 closer to the first short-side portion 122 and an edge 130e in the second direction (Y-axis direction) of a surface 130s of the piezoelectric body 131 of the unimorph piezoelectric vibrator 130 illustrated in FIG. 2 closer to the frame body 120 is about 1.3 or less times the lateral dimension L2 in the first direction (X-axis direction) inside the frame body 120, for example.

FIG. 5 is a sectional view illustrating the structure of the unimorph piezoelectric vibrator of the ultrasonic transducer according to example embodiment 1 of the present invention. As illustrated in FIG. 1, the unimorph piezoelectric vibrator 130 is attached to the frame bodies 120 and faces the first diaphragm 110 with a space therebetween. Specifically, the unimorph piezoelectric vibrator 130 is attached to the other ends in the third direction (Z-axis direction) of the pair of long-side portions 121 and the second short-side portion 123 of each of the frame bodies 120 and faces the first diaphragm 110 with an inner space of each of the frame bodies 120 therebetween.

As illustrated in FIGS. 1, 2, and 5, the unimorph piezoelectric vibrator 130 is a piezoelectric element including the piezoelectric body 131. As illustrated in FIG. 5, in the present example embodiment, the piezoelectric body 131 is sandwiched between a first electrode 132 and a second electrode 133. A polarization direction Dp of the piezoelectric body 131 is along the third direction (Z-axis direction). The first electrode 132 and the second electrode 133 are electrically connected to a processing circuit 140 capable of applying an AC voltage.

As illustrated in FIGS. 2 and 4, a plurality of opening portions 110s, which are open at both end portions in the second direction (Y-axis direction) inside each of the plurality of frame bodies 120, are formed in the first diaphragm 110. That is, two opening portions 110s are provided at both end portions in the second direction (Y-axis direction) inside each of the frame bodies 120 of the first diaphragm 110, and a total of four opening portions 110s are provided in the first diaphragm 110 in the example illustrated in FIG. 2.

The plurality of frame bodies 120 extend in the first direction (X-axis direction). In the present example embodiment, a dimension SL of the plurality of opening portions 110s in the first direction (X-axis direction) is about 67% or more and about 94% or less of the lateral dimension L2 in the first direction (X-axis direction) inside the frame body 120, for example. However, the dimension SL of the plurality of opening portions 110s in the first direction (X-axis direction) may be less than about 67% of the lateral dimension L2 or may be more than about 94% of the lateral dimension L2, for example.

In the present example embodiment, a width dimension SW of the plurality of opening portions 110s is about 0.4 mm or more and about 0.6 mm or less, for example. Each of the opening portions 110s extends from the position on the edge in the second direction (Y-axis direction) of the inner peripheral surface of the frame body 120 to the position the width dimension SW inward in the second direction (Y-axis direction).

The width dimension SW of the opening portion 110s in the second direction (Y-axis direction) is preferably smaller to increase the area of the vibrational region of the first diaphragm 110. When the first diaphragm 110 and the frame body 120 are joined to each other by an adhesive, the width dimension SW of the opening portion 110s in the second direction (Y-axis direction) is preferably about 0.4 mm or more and about 0.6 mm or less, for example, to prevent the opening portions 110s from being blocked by the adhesive that has entered the opening portion 110s near the edge in the second direction (Y-axis direction) of the inner peripheral surface of the frame body 120.

Alternatively, the opening portion 110s preferably has a width dimension of about 0.2 mm or more and about 0.4 mm or less from the position about 0.2 mm inward in the second direction (Y-axis direction) from the position on the edge in the second direction (Y-axis direction) of the inner peripheral surface of the frame body 120. That is, in this case, the width dimension SW is about 0.2 mm or more and about 0.4 mm or less, for example.

Reduction in the acoustic pressure due to release, through the opening portions 110s, of ultrasonic waves generated in a portion of the first diaphragm 110 closer to the frame body 120 can be suppressed to about 10% or less when the relationship f×SW≤90 is satisfied where the driving frequency of the ultrasonic transducer 100 is f (kHz) and the width dimension of the opening portions 110s in the second direction (Y-axis direction) is SW (mm).

It should be noted that, when the opening portions 110s are provided at positions on the edges of the inner peripheral surface of the frame body 120 in the second direction (Y-axis direction), the opening portion 110s can be used to improve the assembly accuracy of the ultrasonic transducer 100 because the amount of lamination deviation between the first diaphragm 110 and the frame body 120 and the amount of adhesive that has protruded to the inside of the frame body 120 can be visually recognized through the opening portion 110s.

In addition, since the opening portions 110s are provided and the internal space inside the frame body 120 communicates with the external space outside the frame body 120 through the opening portions 110s, the internal stress of the ultrasonic transducer 100 can be prevented from increasing by the pressure change in the internal space being reduced when an adhesive for joining, for example, the first diaphragm 110 and the frame body 120 is heated and solidified.

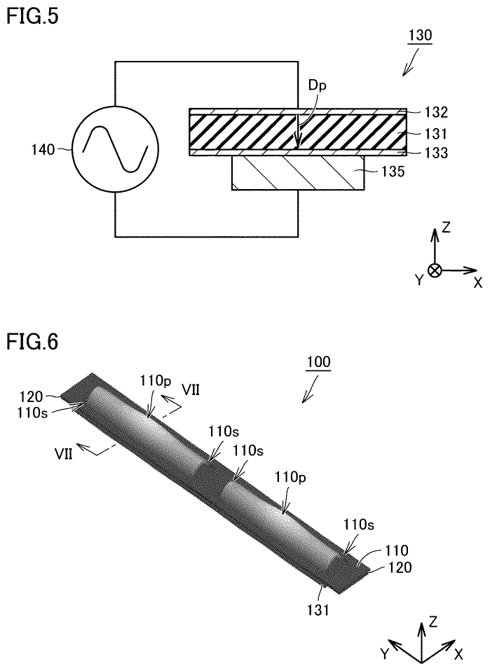

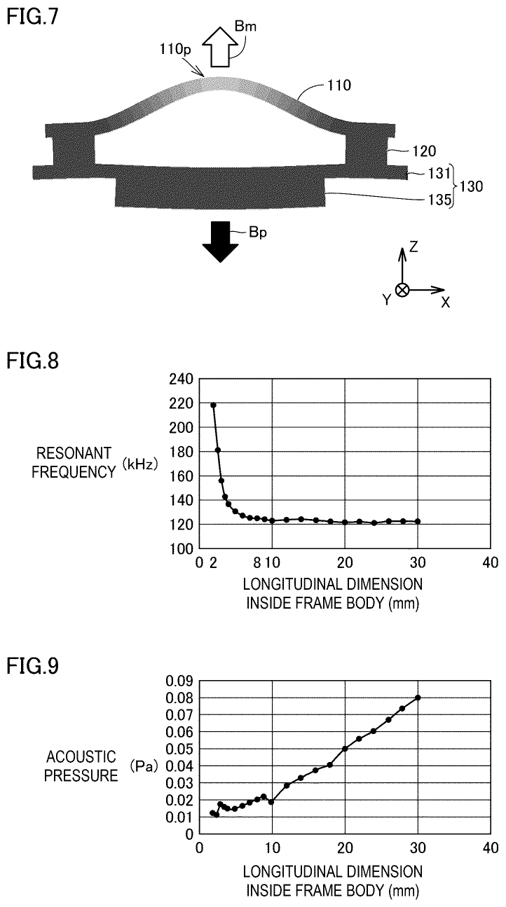

FIG. 6 is a perspective view illustrating a displacement state obtained by simulation analysis using a finite element method when the ultrasonic transducer according to example embodiment 1 of the present invention was transmitting or receiving ultrasonic waves. FIG. 7 is a sectional view of the ultrasonic transducer in FIG. 6 as viewed along arrows VII-VII. In the conditions of simulation analysis, the thickness of the first diaphragm 110 was about 0.1 mm, the thickness of the piezoelectric body 131 was about 0.1 mm, the thickness of the second diaphragm 135 was about 0.2 mm, the longitudinal dimension L1 and the lateral dimension L2 inside the frame body 120 were about 9.85 mm and about 1.8 mm, the thickness of the frame body 120 in the third direction (Z-axis direction) was about 0.2 mm, the distance La between the first short-side portions 122 in the second direction (Y-axis direction) was about 20 mm, the minimum dimension Lm of the piezoelectric body 131 was about 19 mm, the dimension of the second diaphragm 135 in the second direction (Y-axis direction) was about 19 mm, and the dimension of the second diaphragm 135 in the first direction (X-axis direction) was about 1.5 mm, for example. The four opening portions 110s that have a dimension SL in the first direction (X-axis direction) of about 1.42 mm were formed to extend from the positions on the edges in the second direction (Y-axis direction) of the inner peripheral surfaces of the frame bodies 120 to the positions about 0.5 mm inward in the second direction (Y-axis direction), for example. That is, the width dimension SW of the four opening portions 110s was set to about 0.5 mm, for example.

As illustrated in FIGS. 6 and 7, in the vibration mode of the ultrasonic transducer 100 according to example embodiment 1 of the present invention, the first diaphragm 110 is configured to resonantly vibrate in a phase opposite to the phase of the unimorph piezoelectric vibrator 130 in the third direction (Z-axis direction) orthogonal to the first diaphragm 110. That is, as illustrated in FIG. 7, the displacement direction of resonant vibration Bm of the first diaphragm 110 is opposite to the displacement direction of resonant vibration Bp of the unimorph piezoelectric vibrator 130 in the direction (Z-axis direction). In the present example embodiment, the resonant frequency of the first diaphragm 110 and the resonant frequency of the unimorph piezoelectric vibrator 130 are about 100 kHz or higher, for example.

In the first diaphragm 110, a peak portion 110p located in the middle in the longitudinal direction inside the frame body 120 is a node of resonant vibration, and end portions located at both ends in the longitudinal direction inside the frame body 120 are antinodes of the resonant vibration. That is, a portion of the first diaphragm 110 that is located above the inner space of the frame body 120 is the vibrational region that resonantly vibrates. The longitudinal dimension of the vibrational region of the first diaphragm 110 is identical to the longitudinal dimension L1 inside the frame body 120, and the lateral dimension of the vibrational region of the first diaphragm 110 is identical to the lateral dimension L2 inside the frame body 120.

Here, the relationship between the resonant frequency of the first diaphragm 110 and the longitudinal dimension L1 inside the frame body 120 will be described.

FIG. 8 is a graph illustrating the transition of the resonant frequency of the first diaphragm obtained by simulation analysis using a finite element method when the longitudinal dimension was changed with the lateral dimension inside the frame body fixed. In FIG. 8, the vertical axis represents the resonant frequency (kHz) of the first diaphragm 110, and the horizontal axis represents the longitudinal dimension L1 (mm) inside the frame body 120. In the conditions of simulation analysis, only one frame body 120 was provided, and the lateral dimension L2 inside the frame body 120 was fixed to about 2 mm, for example.

As illustrated in FIG. 8, the resonant frequency of the first diaphragm 110 when the longitudinal dimension L1 inside the frame body 120 was about 2 mm was about 220 kHz, and the resonant frequency of the first diaphragm 110 decreased to about 122 kHz when the longitudinal dimension L1 increased to about 8 mm and the longitudinal dimension of the vibrational region of the first diaphragm 110 increased, for example. After that, even when the longitudinal dimension L1 within the frame body 120 became greater than about 8 mm and the longitudinal dimension of the vibrational region of the first diaphragm 110 further increased, the resonant frequency of the first diaphragm 110 remained substantially constant at about 122 kHz, for example.

That is, the resonant frequency of the first diaphragm 110 is determined by the acoustic velocity of the first diaphragm 110 and the reflection of vibration with the frame body 120 used as a fixed end. However, after the longitudinal dimension L1 inside the frame body 120 exceeds about four times the lateral dimension L2, the effect of the lateral dimension L2 on the reflection of vibration becomes dominant, and the state of the reflection of vibration does not change even when the longitudinal dimension L1 is more than about four times the lateral dimension L2.

Next, the following will describe non-limiting examples of the results of simulation analysis using a finite element method of the relationship between the acoustic pressure of ultrasonic waves transmitted by the ultrasonic transducer and the longitudinal dimension L1 inside the frame body 120.

FIG. 9 is a graph illustrating the transition of the acoustic pressure of ultrasonic waves transmitted by the ultrasonic transducer obtained by simulation analysis using a finite element method when the longitudinal dimension was changed with the lateral dimension inside the frame body fixed. In FIG. 9, the vertical axis represents the acoustic pressure (Pa) transmitted by the ultrasonic transducer, and the horizontal axis represents the longitudinal dimension L1 (mm) inside the frame body 120. When only one frame body was provided and the lateral dimension L2 inside the frame body 120 was fixed at 2 mm in the conditions of simulation analysis, the acoustic pressure (Pa) at a position 30 cm away in the Z-axis direction (third direction) from the first diaphragm 110 located on the front surface of the ultrasonic transducer was calculated.

As illustrated in FIG. 9, the acoustic pressure of ultrasonic waves transmitted by the ultrasonic transducer increased as the longitudinal dimension L1 inside the frame body 120 increased. This means that the entire vibrational region of the first diaphragm 110 vibrates even when the longitudinal dimension of the vibrational region of the first diaphragm 110 increases. That is, the area of the vibrational region can be increased by the increase in the length of the vibrational region of the first diaphragm 110, and accordingly, a higher acoustic pressure can be obtained by increasing changes in air pressure due to the vibration of the first diaphragm 110.

Here, the relationship between the longitudinal dimension L1 inside the frame body and the structural stability of the ultrasonic transducer will be described.

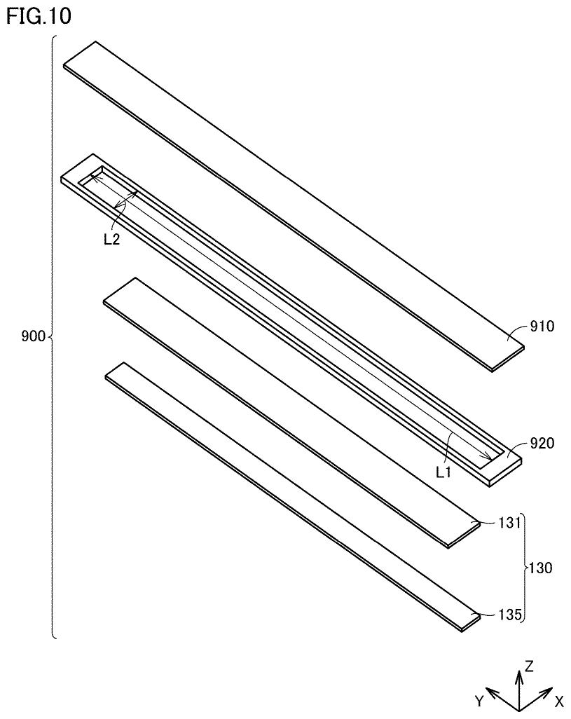

FIG. 10 is an exploded perspective view illustrating the structure of an ultrasonic transducer according to comparative example 1. As illustrated in FIG. 10, an ultrasonic transducer 900 according to comparative example 1 includes a first diaphragm 910, one frame body 920, and the unimorph piezoelectric vibrator 130. Inside the frame body 920, the longitudinal dimension L1 is 30 mm and the lateral dimension L2 is 1.8 mm. No opening portions are formed in the first diaphragm 910. The remaining structure of the ultrasonic transducer 900 other than the above is the same as that of the ultrasonic transducer 100.

FIG. 11 is a perspective view illustrating a displacement state obtained by simulation analysis using a finite element method when the ultrasonic transducer according to comparative example 1 was transmitting or receiving ultrasonic waves. As illustrated in FIG. 11, in the first diaphragm 910 of the ultrasonic transducer 900 according to comparative example 1, a peak portion 910p located in the middle in the longitudinal direction inside the frame body 920 is a node of resonant vibration, and end portions located at both ends in the longitudinal direction inside the frame body 920 are antinodes of the resonant vibration.

Although the example illustrated in FIG. 11 represents a state in which no deformation occurs in the frame body 920, since the rigidity of the frame body 920 reduces when the longitudinal dimension L1 is, for example, 30 mm or more, the frame body 920 may deform such that the lateral dimension L2 increases at a position shifted in the second direction (Y-axis direction) on the frame body 920 when the frame body 920 is pressure-bonded to the piezoelectric body 131. In this case, the position of the peak portion 910p deviates in the second direction (Y-axis direction) from the middle position in the longitudinal direction inside the frame body 920, the resonant frequency of the first diaphragm 910 reduces, and the phase of the displacement of the first diaphragm 910 with respect to an applied voltage by the processing circuit deviates.

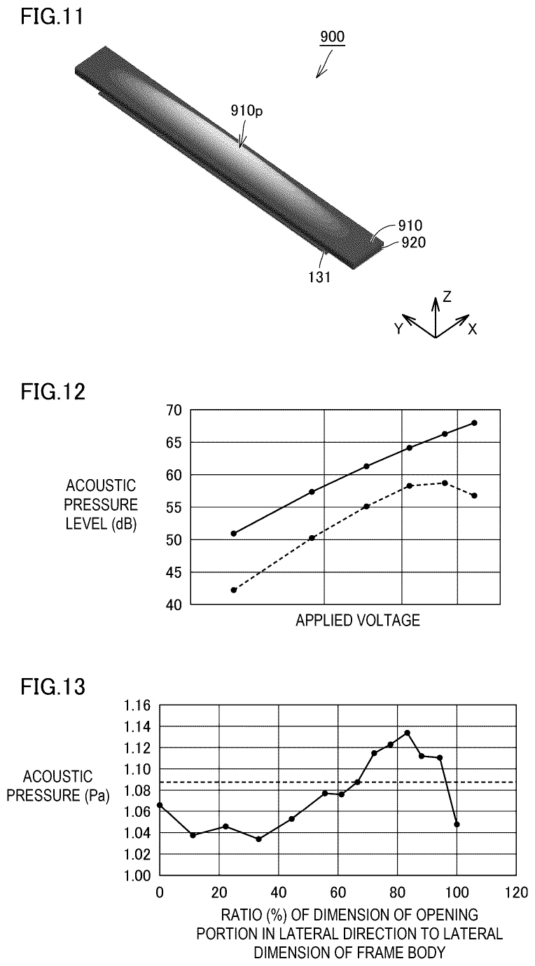

FIG. 12 is a graph obtained by actually measuring the applied voltage by the processing circuit and the transition of the acoustic pressure level for the ultrasonic transducer according to comparative example 1 and an ultrasonic transducer according to example 1 in which two frame bodies are provided and the distance La in the second direction (Y-axis direction) between the first short-side portions is 30 mm. In FIG. 12, the vertical axis represents the acoustic pressure level (dB), and the horizontal axis represents the applied voltage. The data for the ultrasonic transducer according to example 1 is indicated by a solid line, and the data for the ultrasonic transducer 900 according to comparative example 1 is indicated by a dotted line. The acoustic pressure level is the value of the acoustic pressure level of audible sound with a frequency of 3 kHz at a point 30 cm away from the front surface of the ultrasonic transducer in the third direction (Z-axis direction). The applied voltage is a standardized value. The remaining structure of the ultrasonic transducer according to example 1 other than the distance La is the same as that of the ultrasonic transducer 100 according to example embodiment 1.

As illustrated in FIG. 12, the acoustic pressure level of the ultrasonic transducer 900 according to comparative example 1 is lower than that of the ultrasonic transducer according to example 1 over the entire range of the applied voltage. In the ultrasonic transducer 900 according to comparative example 1, when the applied voltage by the processing circuit 140 exceeded a threshold, the joint portion between the first diaphragm 910 and the frame body 920 peeled off, and the acoustic pressure level did not increase even when the applied voltage increased.

In the ultrasonic transducer 900 according to comparative example 1, when the longitudinal dimension L1 was set to about 20 mm, for example, which was approximately 11 times the lateral dimension L2, the joint portion between the first diaphragm 910 and the frame body 920 did not peel off throughout the entire range of the applied voltage, and the acoustic pressure level increased as the applied voltage increased.

Accordingly, in the ultrasonic transducer 100 according to the present example embodiment, since the longitudinal dimension L1 in the second direction (Y-axis direction) is about 4 times or more and about 11 times or less the lateral dimension L2 in the first direction (X-axis direction) inside the plurality of frame bodies 120, the acoustic pressure can be increased with the resonant frequency of the first diaphragm 110 at substantially constant while the joint portion between the first diaphragm 110 and the plurality of frame bodies 120 is suppressed from peeling off.

Here, the following will describe non-limiting examples of the results of simulation analysis using a finite element method of the relationship between the acoustic pressure of ultrasonic waves transmitted by the ultrasonic transducer and the ratio of the dimension SL of the opening portions in the lateral direction to the lateral dimension L2 of the frame body.

FIG. 13 is a graph illustrating the transition of the acoustic pressure of ultrasonic waves transmitted by the ultrasonic transducer obtained by simulation analysis using a finite element method when the dimension of the opening portions in the lateral direction was changed. In FIG. 13, the vertical axis represents the acoustic pressure (Pa) transmitted by the ultrasonic transducer, and the horizontal axis represents the ratio (%) of the dimension SL of the opening portions in the lateral direction to the lateral dimension L2 of the frame bodies. When the longitudinal dimension L1 inside the frame body 120 was fixed at is about 4 times or more and about 11 times or less than about 9.85 mm, the lateral dimension L2 was fixed at about 1.8 mm, and the distance La between the first short-side portions 122 in the second direction (Y-axis direction) was about 20 mm in the conditions of simulation analysis, the acoustic pressure (Pa) at a position about 30 cm away in the third direction (Z-axis direction) from the first diaphragm located on the front surface of the ultrasonic transducer was calculated, for example. The dotted line indicates the acoustic pressure of ultrasonic waves transmitted by the ultrasonic transducer 900 according to comparative example 1 in which the longitudinal dimension L1 was 20 mm and no opening portions were formed in the first diaphragm 910.

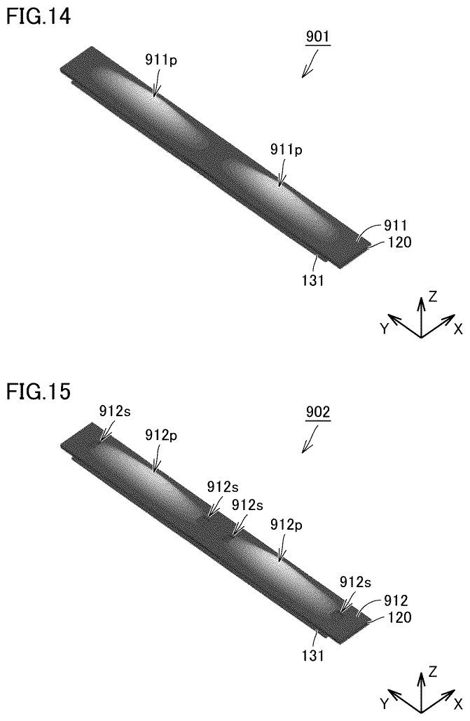

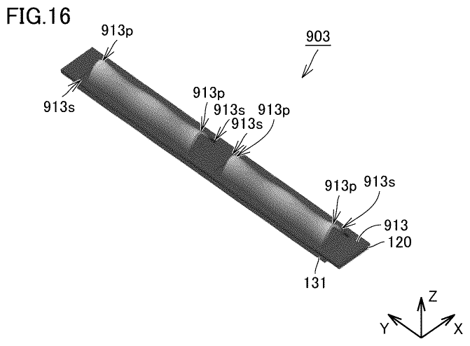

FIG. 14 is a perspective view illustrating a displacement state obtained by simulation analysis using a finite element method when an ultrasonic transducer according to sample 1 in which the ratio of the dimension of the opening portions in the lateral direction to the lateral dimension of the frame body was 0% was transmitting or receiving ultrasonic waves. FIG. 15 is a perspective view illustrating a displacement state obtained by simulation analysis using a finite element method when an ultrasonic transducer according to sample 2 in which the ratio of the dimension of the opening portions in the lateral direction to the lateral dimension of the frame body was about 33% was transmitting or receiving ultrasonic waves. FIG. 16 is a perspective view illustrating a displacement state obtained by simulation analysis using a finite element method when an ultrasonic transducer according to sample 3 in which the ratio of the dimension of the opening portions in the lateral direction to the lateral dimension of the frame body was 100% was transmitting or receiving ultrasonic waves. In samples 1 to 3, the remaining structure of the frame body other than the ratio of the dimension SL of the opening portions in the lateral direction to the lateral dimension L2 of the frame body is the same as that of the ultrasonic transducer 100 according to example embodiment 1 illustrated in FIG. 6.

Since the displacement of a peak portion 911p of the first diaphragm 911 was small in the ultrasonic transducer 901 according to sample 1 in which the ratio of the dimension SL of the opening portions in the lateral direction to the lateral dimension L2 of the frame body was 0% and no opening portions were formed in the first diaphragm 911 as illustrated in FIG. 14, the acoustic pressure of the transmitted ultrasonic waves was lower than that of the ultrasonic transducer 900 according to comparative example 1 as illustrated in FIG. 13.

Since the displacement of a peak portion 912p of the first diaphragm 912 was small in the ultrasonic transducer 902 according to sample 2 in which the first diaphragm 912 had opening portions 912s in which the ratio of the dimension SL of the opening portions in the lateral direction to the lateral dimension L2 of the frame body was about 33% as illustrated in FIG. 15, the acoustic pressure of transmitted ultrasonic waves was lower than that of the ultrasonic transducer 900 according to comparative example 1 as illustrated in FIG. 13.

In the ultrasonic transducer 100 according to example embodiment 1 in which the first diaphragm 110 had the opening portions 110s in which the ratio of the dimension SL of the opening portions in the lateral direction to the lateral dimension L2 of the frame body was 79% as illustrated in FIG. 6, the displacement of the peak portion 110p of the first diaphragm 110 was large, and the acoustic pressure of transmitted ultrasonic waves was higher than that of the ultrasonic transducer 900 according to comparative example 1 as illustrated in FIG. 13. When the ratio of the dimension SL of the opening portions in the lateral direction to the lateral dimension L2 of the frame body falls within the range of about 67% or more and about 94% or less as illustrated in FIG. 13, for example, the entire vibrational region of the first diaphragm vibrated, and an acoustic pressure higher than that of the ultrasonic transducer 900 according to comparative example 1 could be obtained.

In the ultrasonic transducer 903 according to sample 3 in which the first diaphragm 913 had opening portions 913s in which the ratio of the dimension SL of the opening portions in the lateral direction to the lateral dimension L2 of the frame body was 100% as illustrated in FIG. 16, peak portions 913p of the first diaphragm 913 were located near the opening portions 913s, and stress acted on the joint portion between the frame body 120 and the first diaphragm 913 located near the opening portions 913s in a concentrated manner, and the acoustic pressure of transmitted ultrasonic waves was lower than that of the ultrasonic transducer 900 according to comparative example 1 as illustrated in FIG. 13.

Accordingly, in the ultrasonic transducer 100 according to the present example embodiment, since the ratio of the dimension SL of the opening portions in the lateral direction to the lateral dimension L2 of the frame body is about 67% or more and about 94% or less, for example, a high acoustic pressure can be obtained by vibrating the entire vibrational region of the first diaphragm 110 to obtain a high acoustic pressure, and stress can be prevented from concentrating on the joint portion between the first diaphragm 110 located near the opening portions 110s and the frame body 120.

Here, the following will describe non-limiting examples of the results of simulation analysis using a finite element method of the relationship between the acoustic pressure of ultrasonic waves transmitted by an ultrasonic transducer according to comparative example 2 in which two opening portions corresponding one-to-one to the two frame bodies 120 are formed and the ratio of the dimension SL of the opening portions in the lateral direction to the lateral dimension L2 of the frame body.

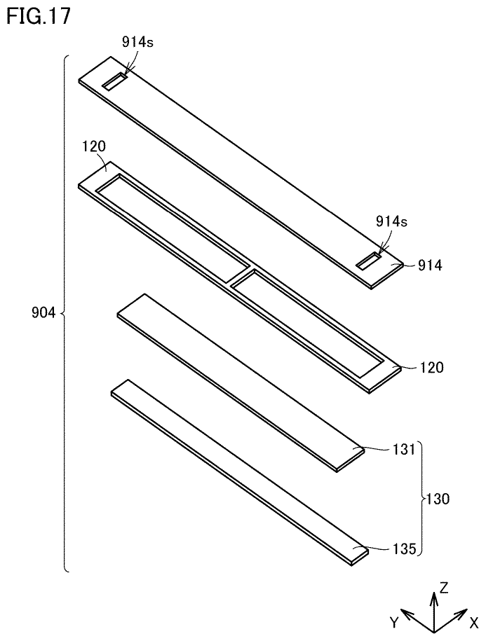

FIG. 17 is an exploded perspective view illustrating the structure of the ultrasonic transducer according to comparative example 2. As illustrated in FIG. 17, an ultrasonic transducer 904 according to comparative example 2 includes a first diaphragm 914, the two frame bodies 120, and the unimorph piezoelectric vibrator 130. The first diaphragm 914 has two opening portions 914s corresponding one-to-one to the two frame bodies 120. Specifically, of the two frame bodies 120, one opening portion 914s that is open on the one side in the second direction (Y-axis direction) is formed inside the frame body 120 located on the one side, and another opening portion 914s that is open on the other side in the second direction (Y-axis direction) is formed inside the frame body 120 located on the other side. The remaining structure of the ultrasonic transducer 904 other than the above is the same as that of the ultrasonic transducer 100.

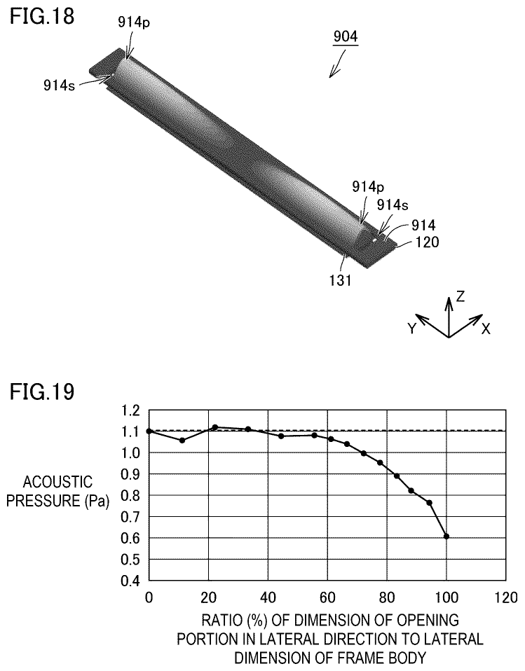

FIG. 18 is a perspective view illustrating a displacement state obtained by simulation analysis using a finite element method when the ultrasonic transducer according to comparative example 2 was transmitting or receiving ultrasonic waves.

FIG. 19 is a graph illustrating the transition of the acoustic pressure of ultrasonic waves transmitted by the ultrasonic transducer according to comparative example 2 obtained by simulation analysis using a finite element method when the dimension of the opening portion in the lateral direction was changed. In FIG. 19, the vertical axis represents the acoustic pressure (Pa) transmitted by the ultrasonic transducer, and the horizontal axis represents the ratio (%) of the dimension SL of the opening portion in the lateral direction to the lateral dimension L2 of the frame body. When the longitudinal dimension L1 inside the frame body 120 was fixed at about 9.85 mm, the lateral dimension L2 was fixed at about 1.8 mm, and the distance La between the first short-side portions 122 in the second direction (Y-axis direction) was about 20 mm in the conditions of simulation analysis, the acoustic pressure (Pa) at a position about 30 cm away in the third direction (Z-axis direction) from the first diaphragm located on the front surface of the ultrasonic transducer was calculated, for example. The dotted line indicates the acoustic pressure of ultrasonic waves transmitted by the ultrasonic transducer 900 according to comparative example 1 in which the longitudinal dimension L1 was 20 mm and no opening portions were formed in the first diaphragm 910.

As illustrated in FIG. 18, in the ultrasonic transducer 904 according to comparative example 2, peak portions 914p of the first diaphragm 914 were located near the opening portions 914s, and stress acted on the joint portions between portions of the first diaphragm 914 located near the opening portion 914s and the frame bodies 120 in a concentrated manner, and, as illustrated in FIG. 19, in the range in which the ratio of the dimension SL of the opening portions 914s in the lateral direction to the lateral dimension L2 of the frame body is about 60% or more, for example, the acoustic pressure of transmitted ultrasonic waves was lower than that in the ultrasonic transducer 900 according to comparative example 1.

It could be confirmed from the results described above that, when the two opening portions 914s corresponding one-to-one to the two frame bodies 120 were formed, even if the ratio of the dimension SL of the opening portions 914s in the lateral direction to the lateral dimension L2 of the frame body was increased to about 60% or more, for example, the acoustic pressure of ultrasonic waves transmitted by the ultrasonic transducer could not be increased.

Next, the following will describe non-limiting examples of the results of simulation analysis using a finite element method of resonant vibration of the first diaphragm of an ultrasonic transducer according to comparative example 3 in which two opening portions corresponding to one of the two frame bodies 120 are formed, and one opening portion corresponding to the other of the two frame bodies 120 is formed.

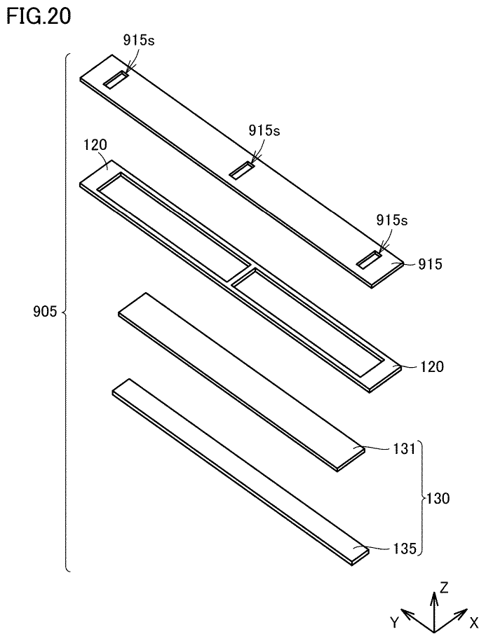

FIG. 20 is an exploded perspective view illustrating the structure of the ultrasonic transducer according to comparative example 3. As illustrated in FIG. 20, an ultrasonic transducer 905 according to comparative example 3 includes a first diaphragm 915, the two frame bodies 120, and the unimorph piezoelectric vibrator 130. The first diaphragm 915 has one opening portion 915s corresponding to one of the two frame bodies 120, and two opening portions 915s corresponding to the other of the two frame bodies 120. Specifically, of the two frame bodies 120, the one opening portion 915s that is open on the one side inside the frame body 120 located on one side in the second direction (Y-axis direction) is formed, and the two opening portions 915s that are open on the other side inside the frame body 120 located on the other side in the second direction (Y-axis direction) are formed. The remaining structure of the ultrasonic transducer 905 other than the above is the same as that of the ultrasonic transducer 100.

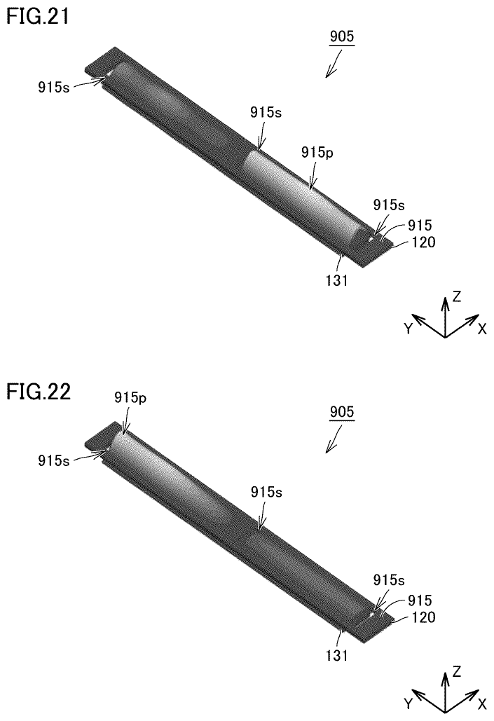

FIG. 21 is a perspective view illustrating a displacement state obtained by simulation analysis using a finite element method when the ultrasonic transducer according to comparative example 3 was transmitting or receiving ultrasonic waves with a frequency of 150 kHz. FIG. 22 is a perspective view illustrating a displacement state obtained by simulation analysis using a finite element method when the ultrasonic transducer according to comparative example 3 was transmitting or receiving ultrasonic waves with a frequency of 150.4 kHz.

As illustrated in FIG. 21, when the ultrasonic transducer 905 according to comparative example 3 was transmitting or receiving ultrasonic waves with a frequency of 150 kHz, a peak portion 915p located in the middle in the longitudinal direction inside the frame body 120 located on the other side in the second direction (Y-axis direction) in the first diaphragm 915 was a node of resonant vibration, and the displacement of the vibrational region covering the inside of the frame body 120 located on one side in the second direction (Y-axis direction) was smaller.

As illustrated in FIG. 22, when the ultrasonic transducer 905 according to comparative example 3 was transmitting or receiving ultrasonic waves with a frequency of 150.4 kHz, the peak portion 915p of the vibrational region covering the inside of the frame body 120 located on one side in the second direction (Y-axis direction) in the first diaphragm 915 was located near the opening portion 915s, and the displacement of the vibrational region covering the inside of the frame body 120 located on the other side in the second direction (Y-axis direction) was smaller.

As illustrated in FIGS. 21 and 22, in the ultrasonic transducer 905 according to comparative example 3 that had two opening portions corresponding to one of the two frame bodies 120 and one opening portion corresponding to the other of the frame bodies 120, the vibration modes of the vibrational regions covering the two frame bodies 120 of the first diaphragm 915 differed from each other and the displacements also differed from each other, and accordingly, the acoustic pressure of ultrasonic waves transmitted by the ultrasonic transducer 905 could not be increased.

Therefore, in the ultrasonic transducer 100 according to the present example embodiment, the first diaphragm 110 has the plurality of opening portions 110s that are open at both end portions in the second direction (Y-axis direction) inside the plurality of frame bodies 120, the acoustic pressure of ultrasonic waves transmitted by the ultrasonic transducer 100 can be increased by matching the vibration modes and the displacements of the vibrational regions covering the plurality of frame bodies 120 in the first diaphragm 110.

Here, the following will describe non-limiting examples of the results of simulation analysis using a finite element method of resonant vibration of the first diaphragm of an ultrasonic transducer according to comparative example 4 in which the difference between the longitudinal dimensions L1 of frame bodies adjacent to each other in the second direction (Y-axis direction) of the plurality of frame bodies exceeds the lateral dimensions L2.

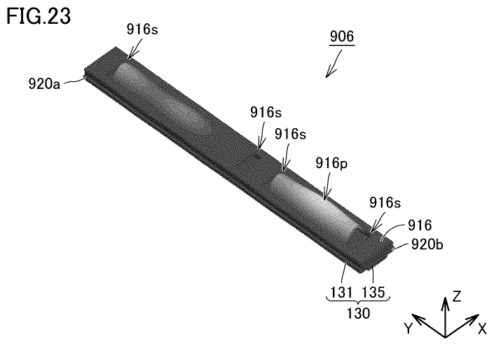

FIG. 23 is a perspective view illustrating a displacement state obtained by simulation analysis using a finite element method when the ultrasonic transducer according to comparative example 4 was transmitting or receiving ultrasonic waves. As illustrated in FIG. 23, an ultrasonic transducer 906 according to comparative example 4 includes a first diaphragm 916, a frame body 920a, a frame body 920b, and the unimorph piezoelectric vibrator 130. In the conditions of simulation analysis, the longitudinal dimension L1 inside the frame body 920a was about 11.8 mm, the longitudinal dimension L1 inside the frame body 920b was about 8.2 mm, and the lateral dimension L2 of the frame body 920a and the frame body 920b was about 1.8 mm, for example. The remaining structure of the ultrasonic transducer 906 other than the above is the same as that of the ultrasonic transducer 100.

As illustrated in FIG. 23, when the ultrasonic transducer 906 according to comparative example 4 was transmitting or receiving ultrasonic waves, a peak portion 916p located in the middle in the longitudinal direction inside the frame body 920b located on the other side in the second direction (Y-axis direction) on the first diaphragm 916 was a node of resonant vibration, and the displacement of the vibrational region covering the inside of the frame body 920a located on one side in the second direction (Y-axis direction) was smaller. Accordingly, the acoustic pressure of ultrasonic waves transmitted by the ultrasonic transducer 906 was about 30% lower than that of the ultrasonic transducer in which the longitudinal dimensions L1 of frame bodies 120 adjacent to each other in the second direction (Y-axis direction) of the plurality of frame bodies 120 were substantially identical to each other.

It should be noted that, when the longitudinal dimension L1 inside frame body 920a was about 10.9 mm, the longitudinal dimensions L1 inside the frame body 920b was about 9.1 mm, and the lateral dimensions L2 of the frame bodies 920a and 920b were about 1.8 mm, the acoustic pressure of ultrasonic waves transmitted by the ultrasonic transducer 906 was about 15% lower than that of the ultrasonic transducer in which the longitudinal dimensions L1 of the frame bodies 120 adjacent to each other in the second direction (Y-axis direction) of the plurality of frame bodies 120 were substantially identical to each other, for example.

Accordingly, in the ultrasonic transducer 100 according to the present example embodiment, the difference between the longitudinal dimensions L1 of the frame bodies 120 adjacent to each other in the second direction (Y-axis direction) of the plurality of frame bodies 120 is equal to or less than the lateral dimension L2. As a result, the acoustic pressure of ultrasonic waves transmitted by the ultrasonic transducer 100 can be maintained high by reducing or preventing the differences in vibration modes and displacements of the vibrational regions covering the plurality of frame bodies 120 in the first diaphragm 110.

Here, the following will describe an ultrasonic transducer according to modification 1 in which one of the two opening portions corresponding to one of the two frame bodies 120 and one of the two opening portions corresponding to the other of the two frame bodies 120 define a common opening portion.

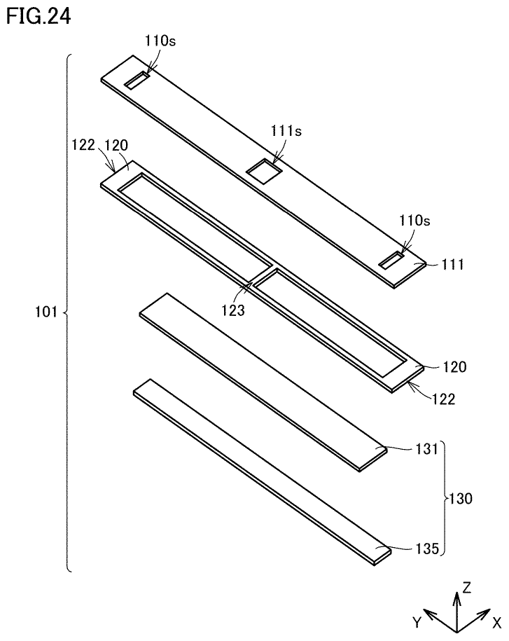

FIG. 24 is an exploded perspective view illustrating the structure of the ultrasonic transducer according to modification 1 of example embodiment 1 of the present invention. As illustrated in FIG. 24, an ultrasonic transducer 101 according to modification 1 includes a first diaphragm 111, the two frame bodies 120, and the unimorph piezoelectric vibrator 130. The first diaphragm 111 includes the two opening portions 110s and one opening portion 111s. Specifically, the opening portion 110s is open on one side in the second direction (Y-axis direction) inside the frame body 120 of the two frame bodies 120 that is located on the one side, and the opening portion 110s is open on the other side inside the frame body 120 that is located on the other side. The opening portion 111s is open on the other side inside the frame body 120 located on one side and on one side inside the frame body 120 located on the other side. The remaining structure of the ultrasonic transducer 101 other than the above is the same as that of the ultrasonic transducer 100.

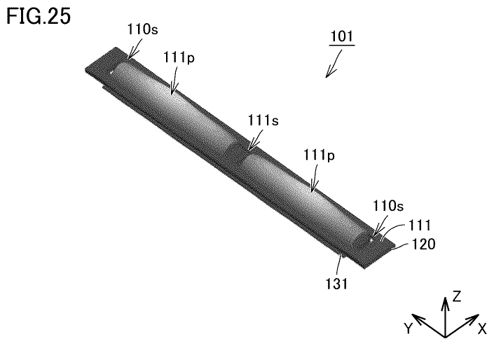

FIG. 25 is a perspective view illustrating a displacement state obtained by simulation analysis using a finite element method when the ultrasonic transducer according to modification 1 was transmitting or receiving ultrasonic waves.

As illustrated in FIG. 25, in the first diaphragm 111, a peak portion 111p located in the middle in the longitudinal direction inside each of the frame bodies 120 is a node of resonant vibration, and end portions located at both ends in the longitudinal direction inside the frame body 120 are antinodes of the resonant vibration. Also in the ultrasonic transducer 101 according to modification 1, it is possible to increase the acoustic pressure level while reducing internal stress by using a simple and small-sized structure as in the ultrasonic transducer 100 according to example embodiment 1.

Here, the following will describe an ultrasonic transducer according to modification 2 in which the piezoelectric body is divided so as to correspond to each of the frame bodies.

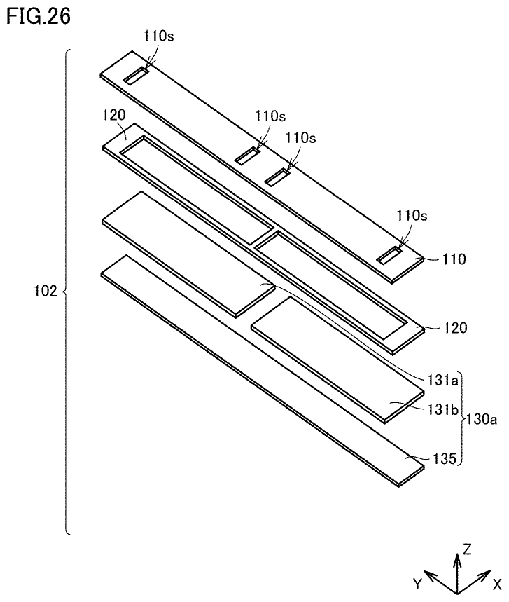

FIG. 26 is an exploded perspective view illustrating the structure of the ultrasonic transducer according to modification 2 of example embodiment 1 of the present invention. As illustrated in FIG. 26, an ultrasonic transducer 102 according to modification 2 includes the first diaphragm 110, the two frame bodies 120, and a unimorph piezoelectric vibrator 130a. The unimorph piezoelectric vibrator 130a includes a first piezoelectric body 131a, a second piezoelectric body 131b, and the second diaphragm 135. The first piezoelectric body 131a is joined to the frame body 120 of the two frame bodies 120 that is located on one side in the second direction (Y-axis direction). The second piezoelectric body 131b is joined to the frame body 120 of the two frame bodies 120 that is located on the other side in the second direction (Y-axis direction). The remaining structure of the ultrasonic transducer 102 other than the above is the same as that of the ultrasonic transducer 100.

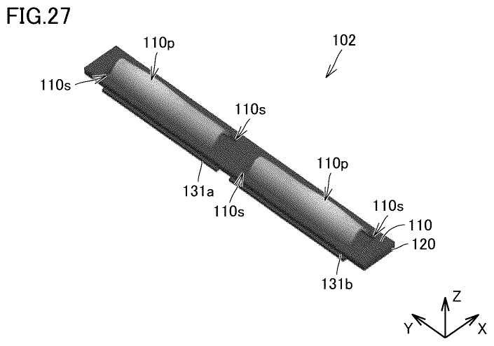

FIG. 27 is a perspective view illustrating a displacement state obtained by simulation analysis using a finite element method when the ultrasonic transducer according to modification 2 was transmitting or receiving ultrasonic waves.

As illustrated in FIG. 27, in the first diaphragm 110, the peak portion 110p located in the middle in the longitudinal direction inside each of the frame bodies 120 is a node of resonant vibration, and end portions located at both ends in the longitudinal direction inside the frame body 120 are antinodes of the resonant vibration.

Also in the ultrasonic transducer 102 according to modification 2, it is possible to increase the acoustic pressure level while reducing internal stress by using a simple and small-sized structure as in the ultrasonic transducer 100 according to example embodiment 1. In addition, since the total volume of the first piezoelectric body 131a and the second piezoelectric body 131b can be smaller than the volume of the piezoelectric body 131 according to example embodiment 1, it is possible to improve the efficiency by reducing the free capacity of the unimorph piezoelectric vibrator 130a and reducing the power consumption of the ultrasonic transducer 102.

Here, an ultrasonic transducer according to modification 3 in which a narrow portion is formed in the second diaphragm will be described.

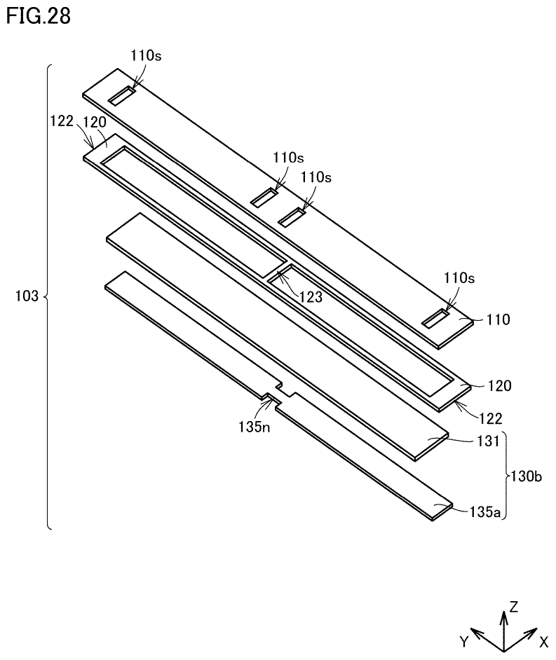

FIG. 28 is an exploded perspective view illustrating the structure of an ultrasonic transducer according to modification 3 of example embodiment 1 of the present invention. As illustrated in FIG. 28, an ultrasonic transducer 103 according to modification 3 includes the first diaphragm 110, the two frame bodies 120, and a unimorph piezoelectric vibrator 130b. The unimorph piezoelectric vibrator 130b includes the piezoelectric body 131 and a second diaphragm 135a. A narrow portion 135n is formed in the second diaphragm 135a. The remaining structure of the ultrasonic transducer 103 other than the above is the same as that of the ultrasonic transducer 100.

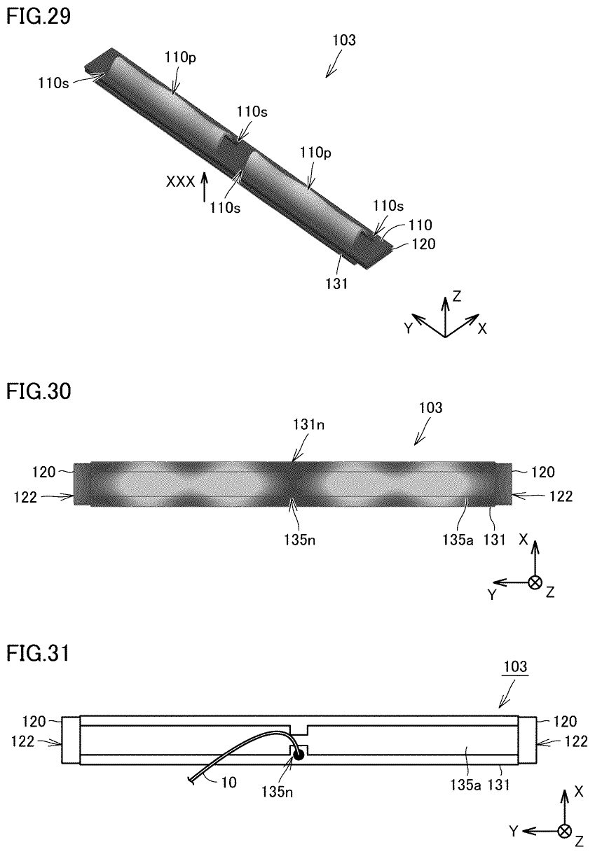

FIG. 29 is a perspective view illustrating a displacement state obtained by simulation analysis using a finite element method when the ultrasonic transducer according to modification 3 was transmitting or receiving ultrasonic waves. FIG. 30 is a diagram of the ultrasonic transducer in FIG. 29 as viewed in the direction of arrow XXX.

As illustrated in FIG. 29, in the first diaphragm 110, the peak portions 110p located in the middle in the longitudinal direction inside the frame bodies 120 are nodes of resonant vibration, and end portions located at both ends in the longitudinal direction inside each of the frame bodies 120 are antinodes of the resonant vibration. As illustrated in FIG. 30, the piezoelectric body 131 has a node point 131n at a position at which the piezoelectric body 131 is joined to the second short-side portion 123 of the frame body 120. The narrow portion 135n of the second diaphragm 135a is located at the node point 131n. That is, the second diaphragm 135a is narrowed to reduce the width in the lateral direction at the position facing the second short-side portion 123, which is a connection end portion between the frame bodies 120 of the plurality of frame bodies 120 adjacent to each other in the longitudinal direction, and facing the node point 131n of the piezoelectric body 131. The narrow portion 135n is formed by pressing, cutting, or the like.

FIG. 31 is a diagram of the ultrasonic transducer according to modification 3 as viewed from the second diaphragm. As illustrated in FIG. 31, in the ultrasonic transducer 103 according to modification 3 of example embodiment 1 of the present invention, the narrow portion 135n is formed at the position described above in the second diaphragm 135a. As a result, a wiring line 10 for supplying power can be easily connected to an electrode provided on the node point 131n of the piezoelectric body 131 exposed through the narrow portion 135n.

Here, the following will describe an ultrasonic transducer according to modification 4 in which three frame bodies 120 are arranged in the second direction (Y-axis direction).

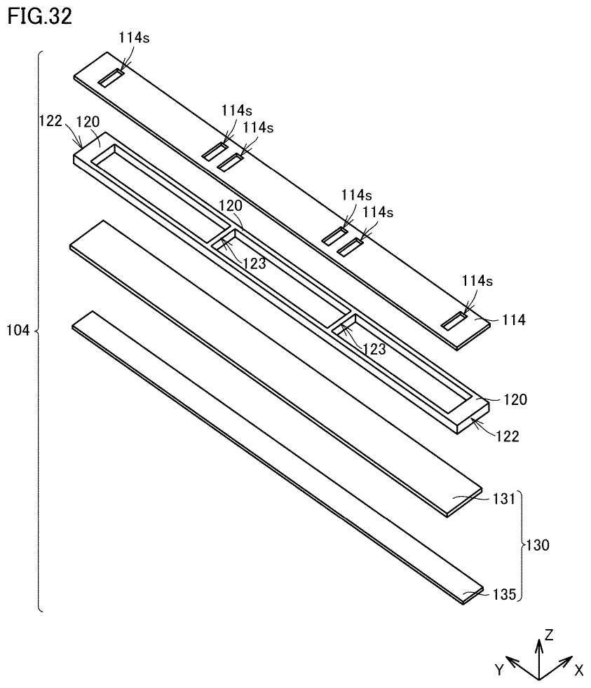

FIG. 32 is an exploded perspective view illustrating the structure of the ultrasonic transducer according to modification 4 of example embodiment 1 of the present invention. As illustrated in FIG. 32, an ultrasonic transducer 104 according to modification 4 includes a first diaphragm 114, the three frame bodies 120, and the unimorph piezoelectric vibrator 130b. Since two opening portions 114s are formed at both end portions in the second direction (Y-axis direction) inside each of the frame bodies 120 in the first diaphragm 114, a total of six opening portions 114s are formed in the first diaphragm 114. The remaining structure of the ultrasonic transducer 104 other than the above is the same as that of the ultrasonic transducer 100.

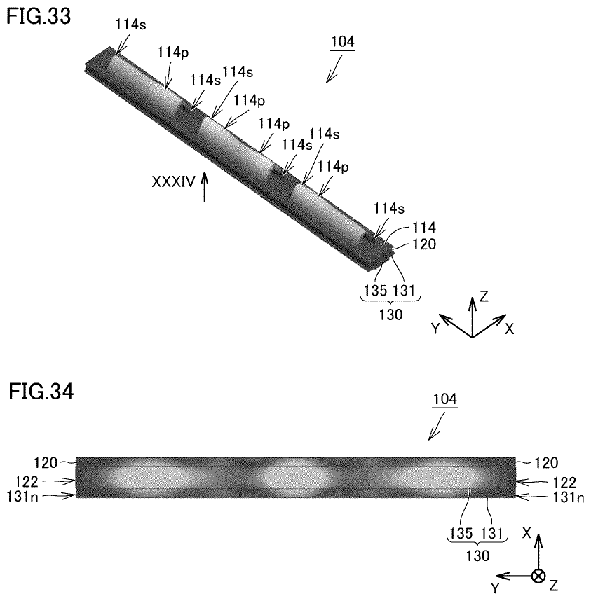

FIG. 33 is a perspective view illustrating a displacement state obtained by simulation analysis using a finite element method when the ultrasonic transducer according to modification 4 was transmitting or receiving ultrasonic waves. FIG. 34 is a diagram of the ultrasonic transducer in FIG. 33 as viewed in the direction of arrow XXXIV. In the conditions of simulation analysis, the longitudinal dimension L1 inside the frame body 120 was about 8 mm, the lateral dimension L2 inside the frame body 120 was about 1.8 mm, and the width dimension W of the second short-side portion 123 was about 0.3 mm, for example.

As illustrated in FIG. 33, the position of each of peak portions 114p slightly deviates from the middle position in the longitudinal direction inside each of the frame bodies 120 in the first diaphragm 114. As illustrated in FIG. 34, the piezoelectric body 131 has the node points 131n at the positions of both end portions in the second direction (Y-axis direction). When the number of frame bodies 120 arranged in the second direction (Y-axis direction) is odd, the positions of both end portions of the piezoelectric body 131 in the second direction (Y-axis direction) were the node points 131n. It should be noted that, even when the width dimension W of the second short-side portion 123 was changed from about 0.3 mm to about 1 mm, for example, the vibration state of the first diaphragm 114 and the positions of the node points 131n of the piezoelectric body 131 did not change.

Here, the following will describe an ultrasonic transducer according to modification 5 in which four frame bodies 120 are arranged in the second direction (Y-axis direction).

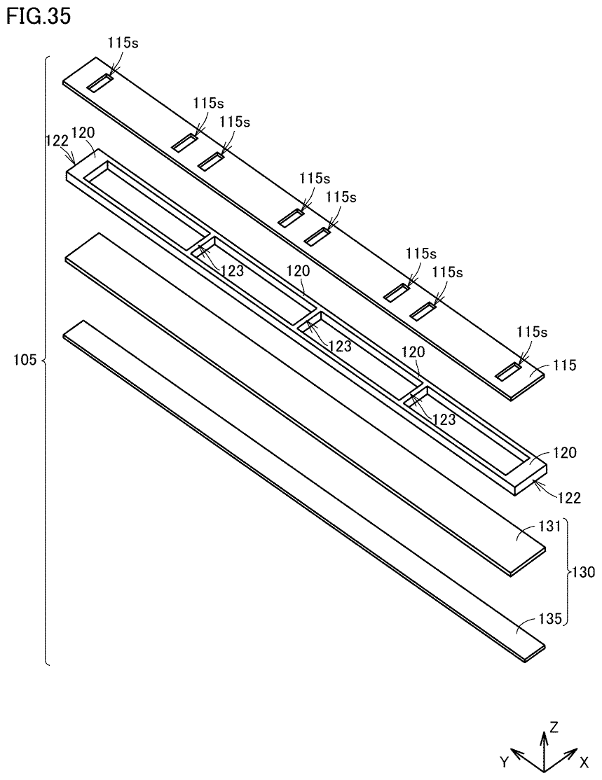

FIG. 35 is an exploded perspective view illustrating the structure of the ultrasonic transducer according to modification 5 of example embodiment 1 of the present invention. As illustrated in FIG. 35, an ultrasonic transducer 105 according to modification 5 includes a first diaphragm 115, the four frame bodies 120, and the unimorph piezoelectric vibrator 130b. Since two opening portions 115s are formed at both end portions in the second direction (Y-axis direction) inside each of the frame bodies 120 in the first diaphragm 115, a total of eight opening portions 115s are formed in the first diaphragm 115. The remaining structure of the ultrasonic transducer 105 other than the above is the same as that of the ultrasonic transducer 100.

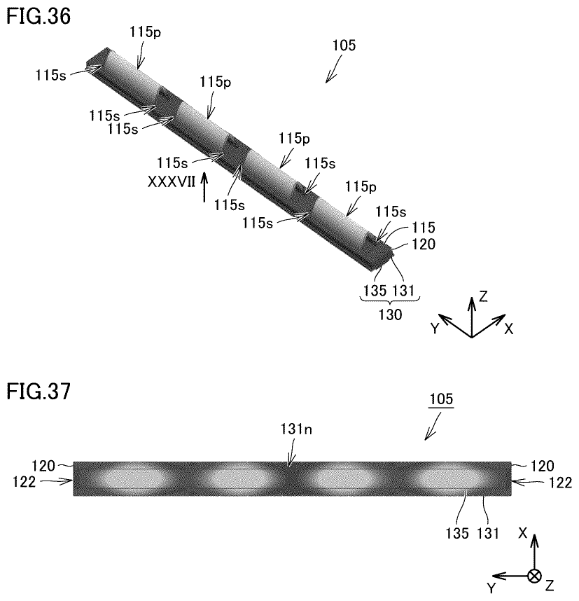

FIG. 36 is a perspective view illustrating a displacement state obtained by simulation analysis using a finite element method when the ultrasonic transducer according to modification 5 was transmitting or receiving ultrasonic waves. FIG. 37 is a diagram of the ultrasonic transducer in FIG. 36 as viewed in the direction of arrow XXXVII. In the conditions of simulation analysis, the longitudinal dimension L1 inside the frame body 120 was about 7.8 mm, the lateral dimension L2 inside the frame body 120 was about 1.8 mm, and the width dimension W of the second short-side portion 123 was about 0.3 mm, for example.

As illustrated in FIG. 36, the peak portion 115p is located in the middle in the longitudinal direction inside each of the frame bodies 120 of the first diaphragm 115. As illustrated in FIG. 37, the piezoelectric body 131 has the node point 131n at the middle position in the second direction (Y-axis direction). As described above, when the number of frame bodies 120 arranged in the second direction (Y-axis direction) is even, the middle position in the second direction (Y-axis direction) of the piezoelectric body 131 was the node point 131n. It should be noted that, even when the width dimension W of the second short-side portion 123 was changed from about 0.3 mm to about 1 mm, for example, the vibration state of the first diaphragm 115 and the position of the node point 131n of the piezoelectric body 131 did not change.

Here, the relationship between the resonant frequency of the first diaphragm and the resonant frequency of the unimorph piezoelectric vibrator 130 in the bending mode will be described.

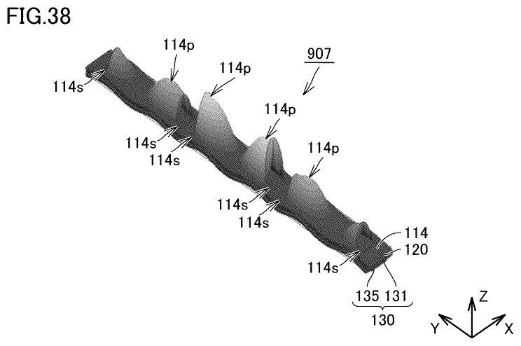

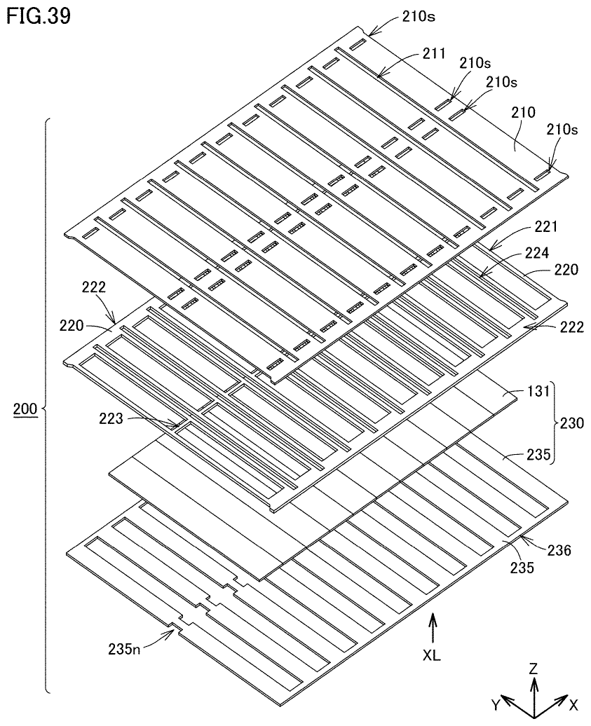

FIG. 38 is a perspective view illustrating a displacement state obtained by simulation analysis using a finite element method when an ultrasonic transducer according to comparative example 5 in which the unimorph piezoelectric vibrator was resonantly vibrating in the bending mode was transmitting or receiving ultrasonic waves. In the conditions of simulation analysis, the thickness of the frame body 120 was about 0.4 mm, and the width dimension W of the second short-side portion 123 was about 0.9 mm, for example. The remaining structure of an ultrasonic transducer 907 according to comparative example 5 other than the above is the same as that of the ultrasonic transducer 104 according to modification 4. It should be noted that the displacement is displayed extremely large in FIG. 38.

As illustrated in FIG. 38, when the unimorph piezoelectric vibrator 130 resonantly vibrates in the bending mode, since the vibration modes and the displacements of the vibrational regions covering the plurality of frame bodies 120 in the first diaphragm 114 cannot be matched with each other, the resonant frequency of the first diaphragm 114 preferably differs from the resonant frequency of the unimorph piezoelectric vibrator 130 in the bending mode by about 10 kHz or more, for example.

In a parametric speaker including the ultrasonic transducer 100 according to example embodiment 1 of the present invention, audible sound can be reproduced by modulating ultrasonic waves emitted from the ultrasonic transducer 100 by modulation driving of the ultrasonic transducer 100. There are two modulation methods: an amplitude modulation method (AM modulation method) and a frequency modulation method (FM modulation method).

In the ultrasonic transducer 100 according to example embodiment 1 of the present invention, the resonant frequency of the first diaphragm 110 and the resonant frequency of the unimorph piezoelectric vibrator 130 are about 100 kHz or higher, for example. When the resonant frequencies are 100 kHz or more, the attenuation of sound waves due to propagation distance is large, and accordingly, audible sound can be reproduced only within limited space. The resonant frequency of the first diaphragm 110 and the resonant frequency of the unimorph piezoelectric vibrator 130 may be, for example, about 150 kHz or more and about 200 kHz or less, for example.

### Example Embodiment 2

An ultrasonic transducer according to example embodiment 2 of the present invention will be described with reference to the drawings. Since the ultrasonic transducer according to example embodiment 2 of the present invention differs from the ultrasonic transducer according to example embodiment 1 of the present invention in that a plurality of unimorph piezoelectric vibrators are disposed in an array, the structure that is the same as that of the ultrasonic transducer according to example embodiment 1 of the present invention will not be described.

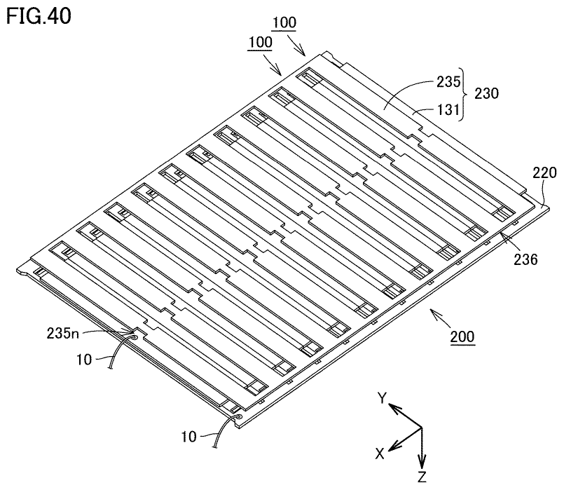

FIG. 39 is an exploded perspective view illustrating the structure of the ultrasonic transducer according to example embodiment 2 of the present invention. FIG. 40 is a back view of the ultrasonic transducer in FIG. 39 as viewed in the direction of arrow XL.

As illustrated in FIGS. 39 and 40, in an ultrasonic transducer 200 according to example embodiment 2 of the present invention, the ultrasonic transducers 100 according to example embodiment 1 disposed in an array in the first direction (X-axis direction) are integrally formed. The ultrasonic transducer 200 includes a first diaphragm 210, a plurality of frame bodies 220, and a plurality of unimorph piezoelectric vibrators 230. The plurality of frame bodies 220 are joined to the first diaphragm 210, and the plurality of unimorph piezoelectric vibrators 230 are joined to the plurality of frame bodies 220, respectively.

Here, a method of manufacturing the ultrasonic transducer 200 will be described. As illustrated in FIG. 39, the first diaphragm 210 is flat and includes a plurality of slits 211, extending in the second direction (Y-axis direction) and positioned at intervals in the first direction (X-axis direction). The first diaphragm 210 includes a plurality of opening portions 210s that are open at both end portions in the longitudinal direction inside each of the plurality of frame bodies 220. The first diaphragm 210 is made of a metal, which is an aluminum alloy, such as duralumin including aluminum, or a stainless steel. In the present example embodiment, the first diaphragm 210 is made of a stainless steel. The plurality of slits 211 and the plurality of opening portions 210s are formed by etching, cutting, or the like.

The plurality of frame bodies 220 have a rectangular or substantially rectangular track shape. The plurality of frame bodies 220 have a lateral direction along the first direction (X-axis direction) and a longitudinal direction along the second direction (Y-axis direction). The plurality of frame bodies 220 extend in the second direction (Y-axis direction). The axial directions of the plurality of frame bodies 220 are along the third direction (Z-axis direction). Each of the plurality of frame bodies 220 includes a pair of long-side portions 221 extending in the second direction (Y-axis direction) and a first short-side portion 222 and a second short-side portion 223 that extend in the first direction (X-axis direction). The first short-side portions 222 are both end portions of each of the plurality of frame bodies 220 located at both ends in the second direction (Y-axis direction). The second short-side portion 223 is a connection end portion of each of the plurality of frame bodies 220 that connects the frame bodies 220 adjacent to each other in the second direction (Y-axis direction). The average distance between the first short-side portion 222 and the second short-side portion 223 is about 4 times or more and about 11 times or less the shortest distance between the long-side portions 221.

The plurality of frame bodies 220 are arranged in a matrix form in both the first direction (X-axis direction) and the second direction (Y-axis direction). Each of slits 224 is between each pair of frame bodies 220 adjacent to each other in the first direction (X-axis direction). The plurality of slits 224 are formed by etching, cutting, or the like. The adjacent long-side portions 221 of the frame bodies 220 adjacent to each other in the first direction (X-axis direction) are separated from each other by the slit 224.

The frame bodies 220 adjacent to each other in the first direction (X-axis direction) are connected to each other by the first short-side portions 222. That is, each pair of frame bodies 220 adjacent to each other in the lateral direction of the plurality of frame bodies 220 is connected to each other by both end portions in the longitudinal direction.

The plurality of frame bodies 220 are formed of a glass epoxy, a resin, or a metal, such as an aluminum alloy or a stainless steel. The plurality of frame bodies 220 are formed of a single thin plate in the present example embodiment, but the present invention is not limited to this example, and the plurality of frame bodies 220 may be integrated with each other by joining the first short-side portions 222 of the plurality of frame bodies 220 including a plurality of thin plates to each other.

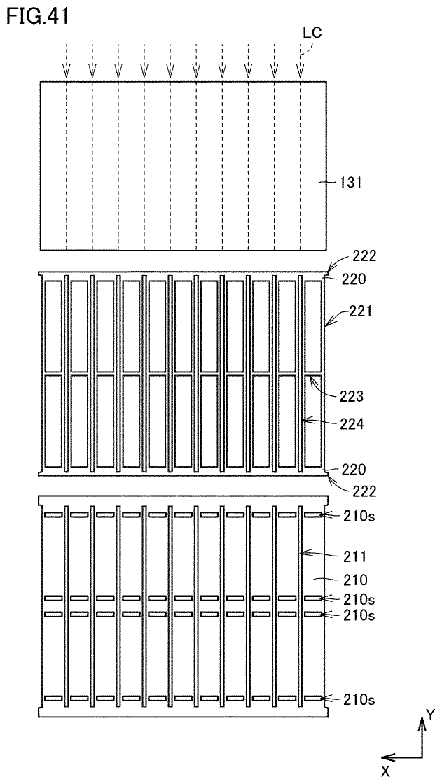

FIG. 41 is a plan view illustrating the positional relationship in the first direction (X-axis direction) in the process of cutting the piezoelectric body of the ultrasonic transducer according to example embodiment 2 of the present invention. As illustrated in FIG. 41, the slits 211 and the slits 224 are disposed at the same position in the first direction (X-axis direction) so as to overlap each other in the third direction (Z-axis direction). The piezoelectric body 131 is cut and divided by a dicer or the like along a plurality of cut lines LC extending in the second direction (Y-axis direction) such that the slits 211 and the slits 224 overlap each other in the third direction (Z-axis direction).

As illustrated in FIGS. 39 and 40, second diaphragms 235 adjacent to each other in the first direction (X-axis direction) are connected to each other by junction portions 236 at positions near both end portions in the second direction (Y-axis direction). The junction portions 236 extend in the first direction (X-axis direction). The junction portions 236 are formed by etching, pressing, cutting, or the like.

The second diaphragm 235 has narrow portions 235n at positions facing the second short-side portions 223, which are connection end portions between the frame bodies 220 adjacent to each other in the longitudinal direction of the plurality of frame bodies 220, and facing the node points of the piezoelectric body 131, such that the widths in the lateral direction are reduced. The narrow portions 235n are formed by half-etching, pressing, cutting, or the like.

In the present example embodiment, the frame bodies 220 and the second diaphragms 235 are plated with Ag or the like. The frame bodies 220 and the piezoelectric bodies 131 are electrically connected to each other by pressure bonding, and the piezoelectric bodies 131 and the second diaphragms 235 are also electrically connected to each other by pressure bonding. As a result, as illustrated in FIG. 40, the plurality of unimorph piezoelectric vibrators 230 become drivable by connecting the wiring lines 10 for supplying power to the piezoelectric bodies 131 to only two portions, which are the end portion in the second direction (Y-axis direction) of the frame bodies 220 and the electrode of the piezoelectric body 131 exposed through the narrow portion 235n.

In the ultrasonic transducer 200 according to example embodiment 2, the acoustic pressure level can be easily increased by increasing the number of ultrasonic transducers 100.

In a parametric speaker including the ultrasonic transducer 200 according to example embodiment 2 of the present invention, audible sound can be reproduced by modulating ultrasonic waves emitted from the ultrasonic transducer 200 by modulation driving of the ultrasonic transducer 200.

In the parametric speaker including the ultrasonic transducer 200 according to the present example embodiment that transmits ultrasonic waves with a high frequency of 100 kHz or more, audible sound can be reproduced only within a limited space by suppressing sound from reaching an unnecessarily far position and sound from leaking due to unnecessary reflection. In addition, since the ultrasonic transducer 200 can increase the attenuation of audible sound due to the propagation distance without a structure for transmitting carrier waves in an opposite phase as in Japanese Patent No. 6333480 being provided, a simplified and small-sized structure can be achieved. Furthermore, ultrasonic waves with a high frequency of about 100 kHz or higher are outside the audible range of animals, such as dogs or cats, effects on these animals can be suppressed.

In the description of the example embodiments described above, combinable structures may be combined with each other.

While example embodiments of the present invention have been described above, it is to be understood that variations and modifications will be apparent to those skilled in the art without departing from the scope and spirit of the present invention. The scope of the present invention, therefore, is be determined solely by the following claims.

What is claimed is:

1. An ultrasonic transducer comprising:
a first diaphragm;
a plurality of frame bodies extending in a longitudinal direction, arranged adjacent to each other in the longitudinal direction, and joined to the first diaphragm; and
at least one unimorph piezoelectric vibrator, attached to the plurality of frame bodies, that includes a piezoelectric body facing the first diaphragm with a space therebetween and a second diaphragm provided on an opposite side of the piezoelectric body from the frame bodies; wherein
the first diaphragm includes a plurality of openings at both end portions in the longitudinal direction inside each of the plurality of frame bodies;
the first diaphragm is configured to resonantly vibrate in a phase opposite to a phase of the at least one unimorph piezoelectric vibrator in a direction orthogonal to the first diaphragm;
inside the plurality of frame bodies, longitudinal dimensions in the longitudinal direction are about 4 times or more and about 11 times or less than lateral dimensions in a lateral direction orthogonal to the longitudinal direction;
the lateral dimensions of the plurality of frame bodies are identical or substantially identical to each other; and
a difference between the longitudinal dimensions of the frame bodies adjacent to each other in the longitudinal direction is equal to or less than the lateral dimensions.

2. The ultrasonic transducer according to claim 1, wherein dimensions of the plurality of openings in the lateral direction are about 67% or more and about 94% or less of the lateral dimensions.

3. The ultrasonic transducer according to claim 1, wherein a resonant frequency of the first diaphragm and a resonant frequency of the at least one unimorph piezoelectric vibrator are about 100 kHz or higher.

4. The ultrasonic transducer according to claim 1, wherein
the plurality of frame bodies are in a matrix in the longitudinal direction and in the lateral direction and are joined to the first diaphragm; and
adjacent frame bodies of the plurality of frame bodies that are adjacent to each other in the lateral direction are connected to each other by both end portions of the adjacent frame bodies in the longitudinal directions.

5. The ultrasonic transducer according to claim 1, wherein the second diaphragm is narrowed to reduce a width in the lateral direction at a position facing a connection end portion between the frame bodies of the plurality of frame bodies adjacent to each other in the longitudinal direction and facing a node point of the piezoelectric body.

6. The ultrasonic transducer according to claim 1, wherein each of the plurality of frame bodies has a rectangular or substantially rectangular track shape.

7. The ultrasonic transducer according to claim 1, wherein each of the plurality of frame bodies includes a glass epoxy, a resin, or a metal.

8. The ultrasonic transducer according to claim 1, wherein a thickness of each of the plurality of frame bodies is about 0.2 mm or more and about 0.6 mm or less.

9. The ultrasonic transducer according to claim 1, wherein the difference between the longitudinal dimensions of the frame bodies adjacent to each other in the longitudinal direction is about 19 mm or more and about 22 mm or less.

10. The ultrasonic transducer according to claim 1, wherein a width of a short-side portion of each of the plurality of frame bodies is about 0.3 mm or more and about 1.0 mm or less.

11. The ultrasonic transducer according to claim 1, wherein each of the lateral dimensions of each of the plurality of frame bodies is about 1.5 mm or more and about 3.0 mm or less.

12. The ultrasonic transducer according to claim 1, wherein the openings include a common opening defined by one of the openings of a first of the plurality of frame bodies and one of the openings of a second of the plurality of frame bodies.

13. The ultrasonic transducer according to claim 1, wherein the plurality of frame bodies include three frame bodies arranged in the longitudinal direction.

14. The ultrasonic transducer according to claim 13, wherein the openings include a total of six openings.

15. The ultrasonic transducer according to claim 1, wherein the plurality of frame bodies include four frame bodies arranged in the longitudinal direction.

16. The ultrasonic transducer according to claim 15, wherein the openings include a total of eight openings.

17. The ultrasonic transducer according to claim 1, wherein the at least one unimorph piezoelectric vibrator includes a plurality of unimorph piezoelectric vibrators positioned in an array.

18. An apparatus comprising the ultrasonic transducer according to claim 1.

19. The apparatus according to claim 18, wherein the apparatus is a parametric speaker, a sensor, or a non-contact haptic device.

20. The apparatus according to claim 19, wherein the parametric speaker has a resonant frequency of about 100 KHz or more.
